(19) United States
(12) Patent Application Publication
(10) Pub. No.: US 2025/0282924 A1
(43) Pub. Date: Sep. 11, 2025

(54) SYSTEM AND METHOD OF SEPARATING COMPOSITE POLYMER OBJECTS

(71) Applicant: Jacques Nicholas Sylvain Bigeau, West Lahave (CA)

(72) Inventor: Jacques Nicholas Sylvain Bigeau, West Lahave (CA)

(21) Appl. No.: 19/169,873

(22) Filed: Apr. 3, 2025

Related U.S. Application Data
(63) Continuation-in-part of application No. PCT/CA2024/051288, filed on Sep. 26, 2024.
(60) Provisional application No. 63/540,914, filed on Sep. 27, 2023.
(60) Provisional application No. 63/586,929, filed on Sep. 29, 2023.

(51) Int. Cl. C08J 11/10; B29B 17/02; B29K 75/00; B29K 309/08

(52) U.S. Cl. CPC C08J 11/10; B29B 17/0206; B29B 2017/0293; B29K 2075/00; B29K 2309/08; C08J 2327/18; C08J 2331/00; C08J 2375/04

(57) ABSTRACT

Various embodiments are described herein for a system and method for breaking down a composite polymer object. The method for breaking down a composite polymer object can comprise: sealing the composite polymer object inside a flexible bag, the composite polymer object comprising an embedded component (such as fibers or fillers) and a polymer matrix component (such as resin); wherein the embedded component and polymer matrix component are chemically bonded; circulating a solvent through the flexible bag, the solvent having a chemical reaction with the composite polymer object that frees the embedded component from the thermoset polymer matrix component, the flexible bag being degradation resistant to the solvent; and recovering the embedded component from the polymer matrix component.

### CROSS-REFERENCE TO RELATED APPLICATION

The present application is a continuation-in-part of PCT/CA2024/051288 filed Sep. 26, 2024, which claims the benefit of priority of U.S. Provisional Patent Application No. 63/540,914 filed Sep. 27, 2023, and U.S. Provisional Patent Application No. 63/586,929 filed Sep. 29, 2023, the contents of which are incorporated herein by reference in their entirety.

### FIELD

The various embodiments described herein generally relate to processes and systems of separating composite polymer objects, and more specially relate to methods of recycling large-scale composite polymer objects.

### BACKGROUND

Recycling is the process of converting waste materials, such as composite polymer objects, into new materials and objects. During the composite polymer object recycling process, materials made from polymers are first separated from other materials.

The separated polymer materials are then washed, shredded and sorted further. The polymer materials are then typically melted and extruded into new recycled plastic pellets, which can be manufactured into a variety of different products. The process of recycling can include various steps such as pre-treatment, breakdown of the components, purification, separation, and post-processing.

Typically, only smaller-scale composite polymer objects can be recycled in a conventional recycling facility. Larger composite polymer objects, such as boat hulls, automotive parts, large furniture items, bathtubs, gas tanks such as hydrogen and oxygen tanks, windmill blades, aircraft parts such as wings, and/or fuselage, and other larger objects are typically more difficult to recycle due to their size. Thus, larger composite polymer objects can end up in landfills where they get broken down into microplastics over hundreds of years.

### SUMMARY OF VARIOUS EMBODIMENTS

In one aspect, in at least one embodiment described herein, there is provided a system and method for breaking down a composite polymer object.

An embodiment of the invention relates to a method for chemically breaking down a composite polymer object. The method optionally involves steps such as: providing a composite polymer object; optionally contacting a surface (e.g., surface can optionally be a single surface, multiple surfaces (such as top and bottom surfaces) or all surfaces) of the composite polymer object with a flow netting; sealing a flexible bag (flexible bag can optionally be a vacuum bag) around the composite polymer object and the flow netting; flowing a solvent into the flexible bag through an inlet feed line fluidly connected to the flexible bag, wherein the solvent circulates along the surface of the composite polymer object and separates, cleaves, or breaks down the embedded fibers or fillers (such as carbon fibers, glass fibers, wood filler, etc.) from the polymer matrix part (such as the resin or matrix part); and removing the polymer fibers from the composite polymer object. In an embodiment, the disclosure provides a method for recycling a composite polymer object, comprising: sealing the composite polymer object inside an envelope, the composite polymer object comprising an embedded component, optionally fibers or fillers, chemically bonded to a polymer matrix component, optionally a resin; applying pressure or vacuum inside the envelope for circulating a solvent in contact with the composite polymer object (the solvent optionally circulating through the envelope), the solvent freeing (releasing) the embedded component from the polymer matrix component; and recovering the embedded component from the polymer matrix component.

After the polymer fiber is removed, the remaining composite polymer object typically comprises a polymer matrix, such as a resin matrix.

The polymer is optionally a composite polymer. Optionally, the polymer is a coating on a frame or other surface (or a portion thereof). The polymer is optionally at least a portion of a boat, such as a boat hull, or a windmill blade.

The flow netting can optionally wrap the composite polymer object if no mold is used. The flow netting can optionally line the surface of a mold that will be used to contact the composite polymer object. The flow media typically improves the circulation of the solvent and improves the contact between the composite polymer object and the solvent. The solvent flows into an inlet (optionally at a first end) of the bag under pressure from a circulating pump fluidly connected to the outlet (optionally at a second end) of the flexible bag. The circulating pump pulls the solvent out of the flexible bag and recirculates the solvent back to the inlet (typically via the reservoir). The solvent typically forms a solvent layer over the composite polymer object. Optionally the pump can be turned off to stop circulation and increase the contact time of the solvent in the flexible bag with the composite polymer object. The method can further optionally comprise providing (optionally preparing) a mold to contact the composite polymer object.

Another embodiment of the invention relates to a recycling system for chemically breaking down a composite polymer object. The recycling system can contain optionally a first reservoir (priming reservoir) containing a solution (e.g., water or another aqueous solution) for priming the recycling system, for example, priming by passing water through the entire system so that the water can push air out of the system to remove the air from the system prior to use (avoid risk of issues such as vapour lock). The first reservoir is typically disconnected from the system after the priming step is completed. Optionally a second reservoir (heating reservoir) is fluidly connected to a solvent reservoir (optionally containing concentrated acid). The second reservoir (optionally diluting the concentrated acid by combination with water in the second reservoir) heats solvent from the solvent reservoir prior to solvent infusion into an infusion system.

Optionally multiple solvents are combined in the second reservoir. Optionally the second reservoir and the solvent reservoir are integrated into a single reservoir. A circulating pump is typically fluidly coupled to the first reservoir during the priming step and fluidly coupled to the second reservoir during the solvent infusion into the recycling system.

In an embodiment, an infusion system is coupled to the circulating pump and the second reservoir, the infusion system can for example contain: Optionally, a flow netting contacting a surface of the composite polymer object for facilitating contact, such as coating or optionally flow (typically even flow, such as flowing in a thin layer, laminar flow, or turbulent flow), of a solvent with, optionally flowing around, the composite polymer object.

The infusion system can for example contain a flexible bag, optionally sealed, having the composite polymer object and the optional flow netting placed within.

The infusion system can for example contain an inlet feed line fluidly connected to the flexible bag (optionally at a first end, inlet end of the flexible bag) for permitting solvent to flow into the flexible bag. When the solvent is flowed into the flexible bag through the inlet feed line, the solvent contacts the surface, and optionally circulates along the surface, of the composite polymer object and separates (cleaves or breaks down) the polymer fiber from the composite polymer object. The circulating pump draws solvent out of the flexible bag through an outlet feed line (optionally at a second end, outlet end of the flexible bag).

In one embodiment, the method for breaking down a composite polymer object comprises: providing a composite polymer object; contacting the composite polymer object with a flow netting; sealing a flexible bag outside of the composite polymer object and the flow netting; flowing a solvent into the flexible bag through an inlet feed line fluidly connected to the flexible bag, wherein the solvent circulates along the surface of the composite polymer object and separates the fiber part from the composite polymer object; and removing the fiber part from the composite polymer object.

In one embodiment, the method further comprises preparing a support, optionally a mold, to support the composite polymer object. The mold shape is complimentary to the composite polymer object. In one embodiment, the method further comprises placing the composite polymer object within the mold; and sealing the flexible bag outside of the composite polymer object, the flow netting; and the mold.

In one embodiment, the method further comprises flowing the solvent solution out of the flexible bag through an outlet feed line. In one embodiment, the method further comprises flushing out the flexible bag using water, solvent, or surfactant.

In one embodiment, the recycling system comprises: a first reservoir for priming the recycling system; a second reservoir fluidly connected to a solution reservoir; the second reservoir heating solution from the solution reservoir and providing it to a circulating pump; the circulating pump fluidly coupled to the first reservoir and the infusion system at a first end and the second reservoir at a second end; the first reservoir providing a constant flow of solution to the circulating pump and catching any air that is trapped within the system; a infusion system coupled to the circulating pump and the second reservoir. The infusion system comprising: a flow netting coupled to the composite polymer object for facilitating even flow of a solvent around the composite polymer object; a sealed flexible bag having the composite polymer object and the flow netting placed within; and an inlet feed line fluidly connected to the flexible bag. Such that when the solvent is flowed into the flexible bag through the inlet feed line, the solvent circulates along the surface of the composite polymer object and separates the embedded component from the matrix component. The circulating pump can draw solution from the second reservoir and feed it to the inlet feed line of the infusion system to break down the composite polymer object using the solution.

In one embodiment, the recycling system further comprises a positive displacement pump coupled to the infusion system for providing a vacuum to the recycling system. In one embodiment, the recycling system further comprises a catch pot coupled to the positive displacement pump for preventing the positive displacement pump from taking in fluids from the recycling system.

In one embodiment, the recycling system further comprises a metering pump fluidly coupled to the second reservoir and the solution reservoir for providing a metered amount of solution from the solution reservoir to the second reservoir.

In one embodiment, the recycling system further comprises a transfer pump coupled to the second reservoir for transferring excess solution out of the second reservoir.

In one embodiment, the recycling system further comprises a transfer container coupled to the transfer pump for containing the excess solution from the second reservoir.

An embodiment of the invention relates to a method for recycling a composite polymer object. The method optionally involves steps such as: sealing the composite polymer object inside a flexible bag fitted with an inlet feed line and an outlet feed line each fluidly connected to the flexible bag; the composite polymer object comprising an embedded component, optionally fibers or fillers, and a polymer matrix component, optionally a resin; wherein the embedded component and polymer matrix component are chemically bonded; circulating a solvent through the flexible bag, the solvent having a chemical reaction with the composite polymer object that frees the embedded component from the polymer matrix component; and recovering the embedded component from the polymer matrix component.

An embodiment of the invention relates to a method for recycling a conglomerate object inside a flexible bag. The method optionally involves steps such as: sealing the conglomerate object inside a flexible bag, the conglomerate object comprising at least a first object of a first material and a second object of a second material; wherein the first object and the second object are chemically bonded; circulating a solvent through the flexible bag, the solvent having a chemical reaction with at least one surface of the conglomerate object that cleaves the first object from the second object, the flexible bag being degradation resistant to the solvent; and recovering the first or second material from the flexible bag.

In at least one embodiment, the first object comprises a composite polymer object and wherein the composite polymer object comprises an embedded component (such as fibers or fillers) and a polymer matrix component (such as resin).

In at least one embodiment, the method further comprises placing a rigid spacer to keep the flexible bag away from the composite polymer object. In at least one embodiment, the rigid spacer comprises at least one of: a flow netting contacting a surface of the composite polymer object; and a plurality of bosses coupled to the flexible bag that contacts a surface of the composite polymer object; for facilitating contact or flow of the solvent around the polymer object.

The method of claim 1, the method further comprises: preparing a mold to support the polymer object, placing the polymer object within the mold, and sealing the flexible bag outside of the polymer object, the flow netting, and the mold.

In at least one embodiment, sealing the flexible bag comprises at least one of: heat-sealing the flexible bag around the polymer object, optionally using an iron; and sealing the flexible bag around the polymer object using sealant tape.

In at least one embodiment, the solvent comprises a first layer and a second layer, the first layer contacted with at least one surface of the polymer object; and the second layer contacted with at least another surface of the polymer object; such that a plurality of the surfaces of the polymer object are covered by the first and second solvent layers.

In at least one embodiment, said recovering the embedded fibers comprises at least one of: removing the polymer substrate from the flexible bag including optionally moving the polymer substrate to a waste storage container; and removing the embedded fibers from the flexible bag.

In at least one embodiment, the method further comprises: flowing the solvent solution out of the flexible bag through the outlet feed line and flushing out the flexible bag using a solvent, surfactant, or water to clean the flexible bag for reuse.

In at least one embodiment, the method further comprises: boring one or more openings in a hollow composite polymer object, the method comprising: such that an interior surface area of the hollow composite polymer object is accessible for a contouring bag or contouring film.

An embodiment of the invention relates to a system for recycling a composite polymer object. In at least one embodiment, the system comprises: a solvent flow path; a solvent reservoir in the solvent flow path, the solvent reservoir containing solvent and having a solvent reservoir outlet, the solvent being degratively reactive with thermoset polymer; a flexible bag in the solvent flow path, the flexible bag having an object compartment, a solvent inlet fluidly connected to the object compartment, and a solvent outlet fluidly connected to the object compartment, the solvent inlet positioned downstream of the solvent reservoir outlet; and a solvent circulation pump positioned in the solvent flow path in fluid communication with the solvent reservoir and the flexible bag.

In at least one embodiment, the solvent reservoir further comprises a heating element for heating the solvent in, or when leaving, the solvent reservoir.

In at least one embodiment, the method further comprises a spacer, optionally a rigid spacer, positioned in the flexible bag to keep the flexible bag away from the composite polymer object.

In at least one embodiment, the spacer comprises at least one of: a flow netting contacting a surface of the composite polymer object; and a plurality of bosses coupled to the flexible bag that contacts a surface of the composite polymer object; for facilitating contact or flow of the solvent around the polymer object.

In at least one embodiment, the method further comprises: preparing a mold to support the polymer object, wherein the mold is composed of at least one of the following: fiberglass, PTFE, vinylester and polyurethane.

In at least one embodiment, the system further comprises at least one of: a positive displacement pump coupled to the solvent inlet of the flexible bag for providing a vacuum to the system; a catch pot coupled to the positive displacement pump for preventing the positive displacement pump from taking in fluids from the system; and a metering pump fluidly coupled to the solvent reservoir for providing a metered amount of solvent to the solvent reservoir to prepare a solvent solution in the solvent reservoir.

In at least one embodiment, multiple solvents are combined in the solvent reservoir.

In at least one embodiment, the system further comprises at least one of: a transfer pump coupled to the second reservoir for transferring excess solution out of the second reservoir and a transfer container coupled to the transfer pump for containing the excess solution from the second reservoir; and a priming reservoir containing an aqueous solution for priming the system and the solvent flow path, wherein the priming reservoir passes water through the system, optionally the entire system, so that the water pushes air out of the system to remove the air from the system prior to use.

In at least one embodiment, a polymer object is placed in the object compartment and wherein the polymer object is at least one of: a thermoset polymer; and at least a portion of a windmill blade or a boat, such as a boat hull.

### BRIEF DESCRIPTION OF THE DRAWINGS

For a better understanding of the various embodiments described herein, and to show more clearly how these various embodiments may be carried into effect, reference will be made, by way of example, to the accompanying drawings which show at least one example embodiment, and in which:

FIG. 1A is an overview of one embodiment of the recycling system;

FIG. 1B is an overview of another embodiment of the recycling system;

FIG. 2 is a diagram of the solvent infusion system;

FIG. 3 is a diagram of the first reservoir set-up;

FIG. 4 is a diagram of the second reservoir set-up;

FIG. 5 is a flow chart showing a method of recycling a material according to one embodiment;

FIG. 6 is a flow chart showing a method of recycling a material according to another embodiment;

FIG. 7A is a block diagram showing an embodiment of the input and output of the recycling system;

FIG. 7B is a block diagram showing an embodiment of the input and output of the recycling system;

FIG. 7C is a block diagram showing an embodiment of the input and output of the recycling system;

FIG. 8A is a block diagram showing an embodiment of the input and output of the recycling system;

FIG. 8B is a block diagram showing an embodiment of the input and output of the recycling system;

FIG. 8C is a block diagram showing an embodiment of the input and output of the recycling system;

FIG. 9 is a block diagram showing an embodiment of the input and output of the recycling system;

FIG. 10A is a block diagram showing an embodiment of the input and output of the recycling system;

FIG. 10B is a block diagram showing an embodiment of the input and output of the recycling system;

FIG. 11A is a block diagram showing a conglomerate object being dissolved by a solvent in a reservoir (left) compared to the recycling system (right);

FIG. 11B is a block diagram showing a conglomerate object being dissolved by a solvent;

FIG. 11C is a block diagram showing a conglomerate object being dissolved by a solvent;

FIG. 11D is a block diagram showing a conglomerate object being dissolved by a solvent;

FIG. 12 is a series of diagrams showing varying architecture of the composite polymer object;

FIG. 13 is a block diagram showing the directional retention of a composite polymer object after the separation process;

FIG. 14A is a depiction showing various composite polymer objects situated inside of envelopes in an open configuration;

FIG. 14B is a depiction of a hollow composite polymer object with a single continuous opening, a contouring bag with a single continuous opening, and a hollow composite polymer object inside of a contouring bag;

FIG. 14C is a depiction of a hollow composite polymer object with two discrete continuous openings, a contouring bag with two discrete continuous openings, and a hollow composite polymer object inside of a contouring bag; and

FIG. 14D is a depiction of a hollow composite polymer object with one discontinuous opening, a contouring bag with one discontinuous opening, and a hollow composite polymer object inside of a contouring bag.

### DETAILED DESCRIPTION OF THE EMBODIMENTS

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

It should be noted that the term “coupled” used herein indicates that two elements can be directly coupled to one another or coupled to one another through one or more intermediate elements.

The various embodiments described herein generally relate to chemical recycling processes, specifically methods to recycle materials made from polymers. Examples of polymers that can be recycled include: thermoplastics, elastomers, bioplastics, polyepoxides, acrylics, copolymers, resins, epoxies, cleavable epoxy resins, recyclable resins, recyclable thermosets, vitrimers, composite polymers, composite resins, fiberglass, thermosets; and/or recyclable resin systems such as cleavable resin systems.

Cleavable resin systems as used herein can refer to a system comprising a polymer matrix component, an embedded component (such as fibers or fillers), and a cleavable curing agent. In at least one embodiment, the cleavable curing agent acts to physically or chemically bond the polymer matrix component to itself. In another embodiment, the cleavable curing agent acts to physically or chemically bonds the embedded components to the polymer matrix component. In at least one embodiment, the cleavable curing agent acts to physically or chemically bond a first embedded component to another embedded component. The cleavable curing agent may include, for example, acetal, ketal, formal, orthoester, orthocarbonate, amine or siloxy functional groups. In one embodiment, the cleavable curing agent includes, but is not limited to recyclamines, or recyclosets.

The cleavable curing agents can be added to a polymer matrix to make a cleavable polymer matrix. An embedded component can be added to a cleavable polymer matrix to form a cleavable resin system. The cleavable curing agents may require a curing process to cure the cleavable resin system. For example, the cleavable resin system can be UV cured, chemically cured, heat cured, light cured, or cured by any other suitable method.

A composite polymer object as used herein refers to an object having embedded component (such as fibers or fillers) and a polymer matrix component (such as resin). The embedded component and polymer matrix component can be initially chemically or physically bonded. A solvent can be reacted with the composite polymer object such that a chemical reaction between the solvent and the composite polymer object can free the embedded component from the thermoset polymer matrix component.

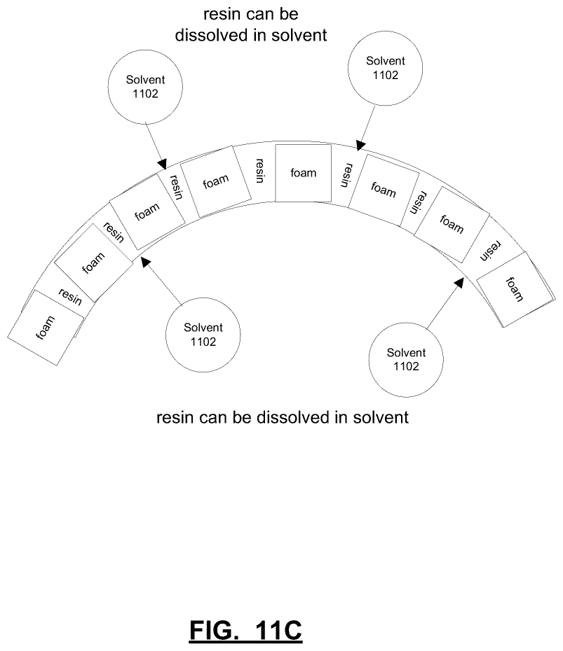

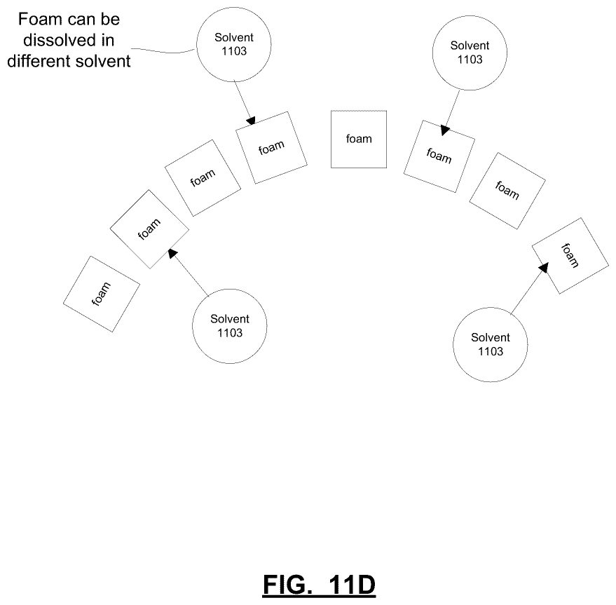

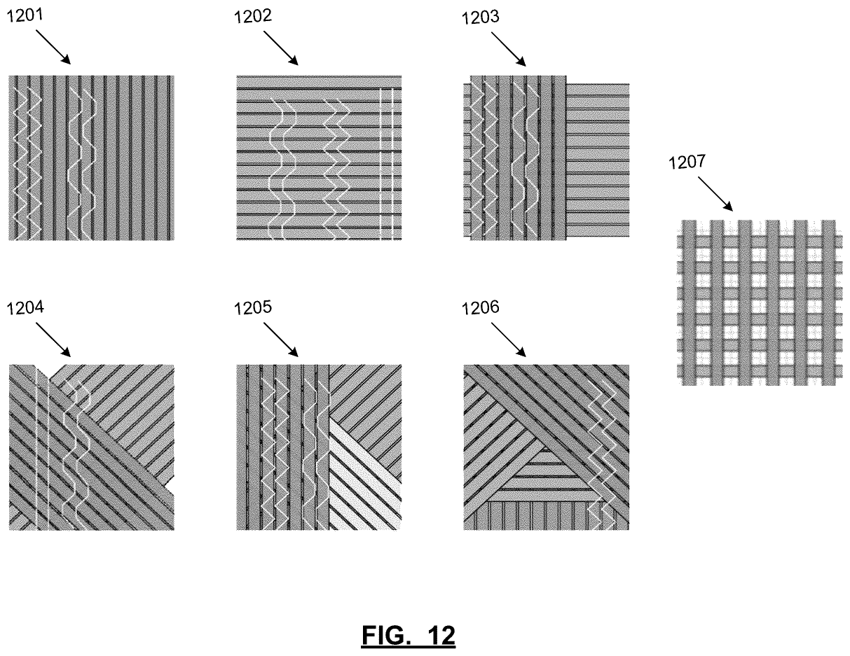

Alternatively, the recycling method can be used for a conglomerate object. The conglomerate object comprises at least a first object of a first material and a second object of a second material. In one embodiment, the first object and the second object can be initially chemically bonded. A solvent can be circulated through the flexible bag, such that a chemical reaction between the solvent and at least one surface of the conglomerate object can cleave the first object from the second object. The first object can optionally be a composite polymer object. The composite polymer object can optionally comprise an embedded component (such as fibers or fillers) and a polymer matrix component (such as resin). The conglomerate object can include a plurality of objects made from metals, alloys, polymers, composites, or any other material objects. The conglomerate object can be, for example, at least a portion of a boat, such as a boat hull, or windmill blades, manufactured scrap material, objects comprising balsa wood, objects comprising foam core, objects comprising metals or alloys, objects comprising paints such as polyurethane paint. For example, the windmill blade (as shown in FIG. 11A-11D) may consist of foam, fiberglass, and resin layers. Optionally, the windmill blade may include metals or wires such as lightning grounding materials or other components that can be physically or chemically bonded to the other materials. Components that are physically bonded (such as via screws or fasteners) may be removed prior to starting the recycling process. Similarly, entire boats (such as kayaks, boats, row boats) may include seats that can be removed prior to the recycling process. The remaining portions of the boat, such as the boat hull, may consist of foam, fiberglass, polymer, metal, paint, wood and resin layers.

During the separation process, materials made from polymers are first separated from other materials. The separated polymer materials are then washed, shredded and sorted further. The polymer materials are then typically melted and extruded into new recycled plastic pellets, which can be manufactured into a variety of different products. Typically, only smaller-scale polymer products can be recycled in a conventional recycling facility. Larger polymer products, such as boat hulls, automotive parts, large furniture items, bathtubs, and other larger products are typically more difficult to recycle due to their size. As the material size is increased, it becomes difficult to break-down the resin due to its size. One solution is to physically break down the material into smaller parts before recycling, however, this can also be difficult as plastics, especially larger or harder plastics may need specialized equipment to cut.

The disclosure provides a method and process for recycling large-scale composite polymer objects, without the need to physically break down the part. In one embodiment, the composite polymer object to be recycled is placed in an envelope such as an envelope bag or envelope film and supported during the process to ensure that once the resin matrix is removed the left over materials are not disturbed. The enveloping bag refers to a bag or sleeve that is used without a mold. The envelope film refers to a bag or sleeve that is used in combination with a mold and sealant tape. The envelope bag or envelope sleeve can be a flexible bag, a rigid bag, flexible case, rigid case, and the like. The envelope film can be a flexible bag, a rigid bag, flexible case, rigid case, and the like. A solvent solution can then be heated and circulated through the flexible bag for a period of time. Once the resin matrix is removed, further cleaning with circulating warm water can take place within the bag. In at least one embodiment, the flexible bag can be cleaned using a solvent, surfactant, or water for reuse. The only material handing occurs when removing the fibers (in large scale fabric form) from the vacuum and drying. The low handling aspects and having the ability to break down any size composite or polymer, without physically cutting the composite polymer object provide advantages to existing solutions of recycling large-scale composite polymer objects.

For example, if one were to consider the challenge of recycling a typical wind turbine blade (that is usually 97 meters longs and 6 meters wide) in a conventional tank or reactor. This example is illustrated in FIG. 11A. Approximately 3,200 tonnes of solvent would be needed to perform this task by immersing the wind turbine blade in an immersion tank. On the other hand, by circulating the solvent under vacuum over just the surface area of the same size wind turbine blade, approximately 1 tonne of solvent would be needed to cover the entire blade. As such, using the process provided herein, the solvent is circulated under vacuum over just the surface area of any size composite part, reducing the volume of solvent needed for large complex geometries of large composite polymer objects and conglomerate objects.

In another embodiment, a method and process for recycling large-scale composite polymer objects is described wherein the composite polymer object to be recycled is placed in a contouring bag or contouring film and supported during the process to ensure that once the resin matrix is removed the left over materials are not disturbed. The contouring bag or contouring film outlines the exterior and interior surface area and shape of the composite polymer object. The contouring bag refers to a bag or sleeve that is used without a mold. The contouring film refers to a bag or sleeve that is used in combination with a mold and sealant tape. The contouring bag or contouring sleeve can be a flexible bag, a rigid bag, flexible case, rigid case, and the like. The contouring film can be a flexible bag, a rigid bag, flexible case, rigid case, and the like. A solvent solution can then be heated and circulated through the flexible bag for a period of time. Once the resin matrix is removed, further cleaning with circulating warm water can take place within the bag.

The use of a contouring bag or contouring film is particularly useful for composite polymer object shapes which are hollow and which have one or more openings, such as hollow cylinders or hollow spheres with one or more openings, where the contouring bag or contouring film outlines both the interior and exterior surface area of the object. The one or more openings may be continuous, such as a hollowed cylinder pipe, or may be discontinuous and form a cavity, such as a storage tank. By utilizing a contouring bag or contouring film which follows both the exterior and interior surface area and shape on composite polymer objects which are hollow and have one or more openings, the volume of solvent required to recycle the object is reduced in comparison to an immersion tank or a bag or film which outlines only the exterior shape of the composite polymer object. This is because the contouring bag or contouring film does not fill as much of the hollow interior volume of the composite polymer object which is not in contact with the composite polymer object, thus reducing the overall solvent volume required for recycling.

For composite polymer object shapes which are hollow but which lack any openings, one or more openings may be bore through the composite polymer object such that the interior surface area is accessible for the contouring bag or contouring film. The one or more openings may be bored through the composite polymer object using any suitable tools and/or methods. In at least some embodiments, the openings may be bored by drilling, cutting, drill press, heating/burning (ex. acetylene torch), or any other suitable boring method.

This method and process involving the use of a contouring bag or contouring film for recycling of composite polymer objects may also be used on conglomerate objects. This includes the boring of conglomerate objects which are hollow to create one or more openings if necessary.

Furthermore, the process described herein is improved when performed under vacuum. Performing the process under vacuum would increase circulation efficiency of the solvent. In some instances, if no vacuum is applied, the solvent or acid could sink to the lowest point of the bag. Putting the envelope bag under vacuum makes it possible to circulate the solvent on all vertical surfaces without pooling. Having the ability to circulate the solvent on all vertical surfaces reduces the volume of solvent needed for large complex geometries. As the fibres in the composite polymer object separate, the more the solvent can flow through the material, flowing through each layer until the entire part is broken down. The vacuum reduces the required amount of solvent needed to run over the materials to separate them.

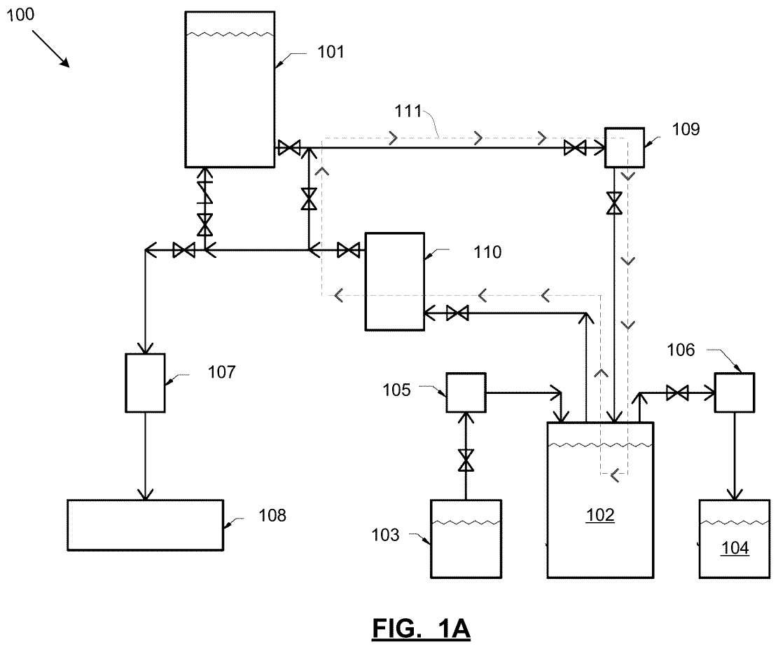

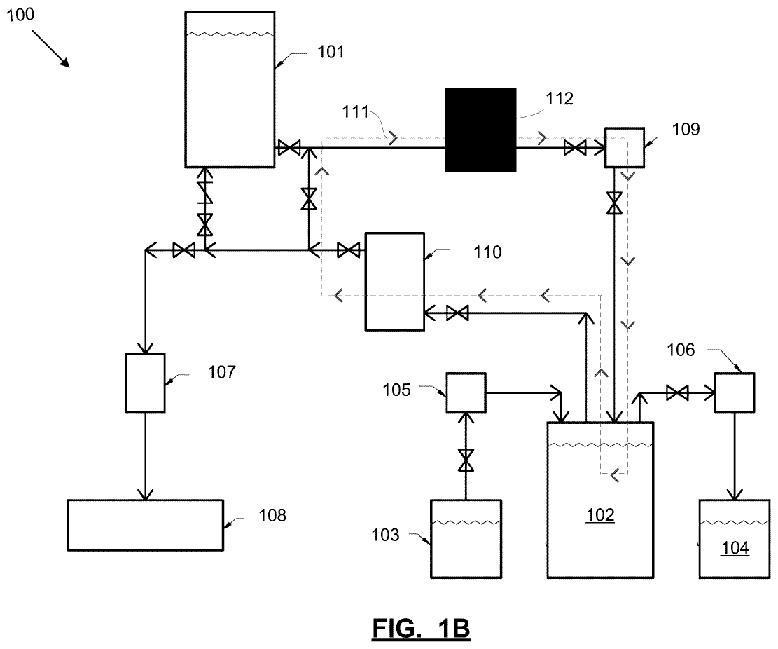

Turning now to the figures, FIG. 1 provides an overview of the recycling system 100. The system comprises a first reservoir 101, a circulating pump 109, a solvent infusion system 110, and a second reservoir 102. The system 100 may additionally comprise a transfer pump 106 connected to a transfer container 104; a metering pump 105 connected to a solvent reservoir 103; and a catch pot 107 connected to a positive displacement pump 108. The parts can be connected to each other via tubing such as polyethylene lines, the solvent flow path 111 can be seen in FIG. 1. The system can comprise a solvent flow path 111; a solvent reservoir 102 in the solvent flow path 111, the solvent reservoir 102 containing solvent and having a solvent reservoir outlet, the solvent can be degratively reactive with thermoset polymers; a flexible bag in the solvent flow path 111, the flexible bag having an object compartment, a solvent inlet fluidly connected to the object compartment, and a solvent outlet fluidly connected to the object compartment, the solvent inlet positioned downstream of the solvent reservoir outlet; and a solvent circulation pump 109 positioned in the solvent flow path 111 in fluid communication with the solvent reservoir 102 and the flexible bag.

The first reservoir 101 can be connected to an outlet side of the solvent infusion system 110 and the circulating pump 109. The first reservoir can be relatively smaller than the second reservoir 102. The first reservoir can be sealed as needed. The function of the first reservoir 101 is to aid in priming the recycling system 100 on startup, by providing a constant flow of solution directly to the circulating pump 109 and catching any air that is trapped within the system.

Once any air trapped in the lines is removed, the first reservoir 101 can be bypassed using shutoff valves. A direct line can then run from the outlet line of the solvent infusion system 110 and the inlet on the circulation pump 109. Vapour can negatively affect the pump 109, creating a vapour lock. If a vapour lock occurs, the system may have to be shut down. If any vapour or off-gas are detected while the system is running, it can be possible to redirect the flow back through the first reservoir 101 in order to catch any vapour before it gets to the circulating pump 109.

The second reservoir 102 (also referred to as the “solvent reservoir” or “heated reservoir”) can be connected between the outlet side of a circulation pump 109 and the inlet feed line to the compositive part system 110. The second reservoir 102 can be relatively larger than the first reservoir. In one embodiment, the second reservoir 102 is not completely sealed, allowing for pressure differentials within the system. The second reservoir 102 can be heated.

Before startup, the solvent infusion system 110 is prepared. To prepare the solvent infusion system 110, the polymer part to be recycled can be placed and sealed in a flexible bag or rigid mold. A flow media can also be coupled to, and placed along with the composite polymer object. Once the composite polymer object and the flow media are placed into the flexible bag, air is removed from the bag with a positive displacement pump 108. Once air is completely removed from the bag, the shut off valves installed on the feed lines are closed and the positive displacement pump 108 is turned off. A leak check can be performed by leaving the solvent infusion system 110 under vacuum for several minutes and recording any pressure drop within that time.

Once the solvent infusion system 110 is prepared, the parts within the system 100 can be primed with water by infusion. The amount of water used for priming can be calculated in order to accurately meter in the right volume of solvent once the system is completely primed and operating. This can be done by connecting the inlet feed line to the second reservoir 102 and connecting the outlet feed line to a positive displacement pump. In order to prevent the positive displacement pump108 from taking in water, a catch pot 107 can be installed between the solvent infusion system 110 and the positive displacement pump 108. The positive displacement pump 108 can be turned on and the valves to the solvent infusion system 110 can be opened. Water is pulled into the flexible bag of the solvent infusion system 110 from the second reservoir 102. The feed lines can then be closed once the solvent infusion system 110 is fully infused with water. A quick disconnect valve can be installed to the positive displacement pump line so the positive displacement pump 108 and the catch pot 107 can be removed from the system after the solvent infusion system 110 is primed.

After the solvent infusion system 110 is disconnected from the positive displacement pump 108 and catch pot 107, the outlet line on the primed solvent infusion system 110 can be connected to the remaining system. The system can be started by turning on the circulating pump 109, which provides a direct feed from the first reservoir 101 to the solvent infusion system 110. As the circulating pump 109 pulls the water from the large tank 102, through the solvent infusion system 110 and first reservoir 101, a vacuum is created. On the outlet side of the pump 109, the water can be pushed into the large tank 102 creating pressure on the outlet side of the circulating pump 109. To equalize any pressure differentials, the system can be run until water levels are maintained in both the first and second reservoirs 101, 102.

Once the system is equalized and any trapped air has been removed, the solvent infusion system 110 and first reservoir 101 can be isolated by shutting off any connecting valves. The circulating pump 109 can then be turned off. A solvent reservoir 103 and a metering pump 105 can be connected to the second reservoir 102. In one embodiment, the solvent reservoir 103 and the metering pump 105 can be connected to the second reservoir 102 by a quick connect valve. In one embodiment, the solvent reservoir 103 contains an acid, such as acetic acid, hydrochloric acid, sulfuric acid, phosphoric acid, nitric acid, lactic acid, formic acid, propionic acid, citric acid, methane sulfonic acid, p-toluene sulfonic acid, benzoic acid, phthalic acid, etc. The solvent can be chosen based on which material is to be recycled. For example, solvents that can break down thermosets, which may include protic or non-protic solvents, such as: ethanolamine, 2-aminoethanol, methoxy-nonafluorobutane, 2-methyltetrahydrofuran, tetra-chloroethylene, n-propyl bromide, dimethyl sulfoxide, polyester oil, esters, ethers, acetates, acids, alkalis, amines, ketones, glycol ethers, glycol ether esters, ether esters, ester-alcohols, halogenated hydrocarbons, paraffinic hydrocarbons, aliphatic hydrocarbons, aromatic hydrocarbons, dimethylformamide, tetrahydrofuran, methylene chloride, acetone, cyclopentane, methanol, chloroform, toluene, ethanol, ethylene glycol, isopropyl alcohol, butyl alcohol, pentanol, hexanol, heptanol, octanol alcohol, nonyl alcohol, water, etc.

The solvent chosen may be used independently or may include a combination of solvents. Care needs to be taken to select the right equipment (tubing, flexible bag material, etc.) for the recycling process. Some plastic equipment materials are not able to withstand high processing temperatures or certain solvents. As such, the proper material must be chosen which is chemically resistant to the solvent used and able to withstand high processing temperatures. For example, Teflon is resistant to almost all solvents and high processing temperatures, making it suitable to be used as a flexible bag material or as a coating for the tubing material for the solvent flow path 111. Additionally, polypropylene, polyethylene and/or nylon can also be used in some embodiments.

The effectiveness of the solvent can be improved by increasing or changing the pressure of the system. The composite polymer object can be primed with solvent in the flexible bag, which may then be placed inside of a pressure chamber, pressure tank, or autoclave housing. The flexible bag can be connected via fittings to the rest of the system through tubing which passes through the pressurized vessel. The solvent can then be circulated through the system as external pressure is applied to the composite polymer object until the composite polymer object has been separated.

Furthermore, each composite polymer object or conglomerate object made up of a plurality of individual materials or composite polymer objects may require differing parameters in which it can break down. Each individual object or material may require the selection of specific processing equipment, solvents, and/or acids based upon their identity so as to safely and efficiently carry out the separation process of the invention.

The concentration of the acid may be up to 100%. In one embodiment, the concentration of solution may be between 20% to 100%. The volume of acid can be calculated from the amount of water already in the system to achieve the desired solvent concentration solution. The circulating pump 109 can be turned on and the feed line valves to the solvent infusion system 110 can be opened. A valve is opened between the solvent infusion system 110 and the circulating pump 109, allowing the water to bypass the first reservoir 101. As the system circulates, the metering pump 105 is turned on and a valve is opened to fill the second reservoir 102 with the correct ratio of solvent or acid from the solvent reservoir 103. Once the second reservoir 102 has been filled, the metering pump 105 is turned off and the line can be disconnected.

The heater coupled to the second reservoir 102 can be turned on with a temperature controller or the like. In some embodiments, ambient temperature can facilitate separation. In some embodiments, the heater can be set between 20-250° C. In some embodiments, the heater can be set between 20-100° C. In one embodiment, the heater can be set to 80° C. In some embodiments, the heater can be set between 70° C. to 100° C. The tubing lines, first reservoir 101, second reservoir 102 and the solvent infusion system 110 can be insulated in order to efficiently heat the system 100. Once the solution reaches the desired temperature, the system can run the duration of 1 hour to over 10 days. In some separation processes, the system can be running for the duration of 8-12 hours, but this can be increased or decreased depending on the part to be recycled.

As the part to be recycled begins to break down, and the matrix component (i.e. resin) can become dissolved into to the solution, the volume of the system can increase. In order to prevent overflow in the second reservoir 102, a transfer pump 106 can be used to remove any excess solvent solution into a closed, transfer container 104 as needed to maintain a safe volume level. The transfer pump 106 can be connected to the second reservoir 102 with a connect valve.

After the composite polymer object has been completely broken down, the embedded fibers or fillers separated during the process can be removed from the solvent infusion system 110.

Once the embedded components or materials have been flushed/cleaned with water (or solvent/surfactant), the solvent solution can be vacuumed or siphoned out of the bag, such as with a pump, and the feed lines can be disconnected. To separate and dry the embedded components, the bag can be cut open on one side and the embedded components be removed and placed on a drying rack. The rack can be in a heat-controlled room to help dry the embedded components. Once the embedded components or materials (fibers, fillers core, inserts, etc.) are dry they can be further processed, tailored or reused as they are.

Having large amounts of recovered materials allows for a wider variety of reuse applications. The larger the part that can be recycled, the more likely the material can be reused without further processing (i.e., pelletizing, shredding etc.) In another embodiment, the recovered materials can be processed further for many other applications. For example, the large fiber pieces can be stitched back into a roll format or chopped and used as filler, the foam melted and pelletized, the resin processed and reused in some applications.

FIG. 1B provides an optional embodiment of the system. In this embodiment, a filter 112 can be placed after the outlet of the flexible bag of the solvent infusion system 110. Filter 112 can be used for precipitating out dissolved materials output from flexible bag. In one embodiment, the filter 112 can be used to filter the embedded components. In another embodiment, the filter 112 can be used to filter the resin or matrix component from the output solvent-resin solution.

The feed line valves to the solvent infusion system 110 can then be closed and the circulation pump 109 can be turned off. The lines to the circulation pump 109 and the solvent infusion system 110 can be disconnected using the quick disconnect valves. A separate set of lines primed with warm water can be connected to the circulation pump 109 and the solvent infusion system 110. A container full of warm water can be connected between the outlet side of the circulation pump 109 and the inlet side of the solvent infusion system 110. The circulation pump 109 can be started, and the feed line valves can be opened on the solvent infusion system 110. The system 100 can be used run multiple cycles this way, replacing the water several times, until the water in the container neutralizes. Once the water is neutral, such as, for example has a pH reading of 7, the system 100 can be turned off. The flexible bag of the solvent infusion system 110 can be removed for drying.

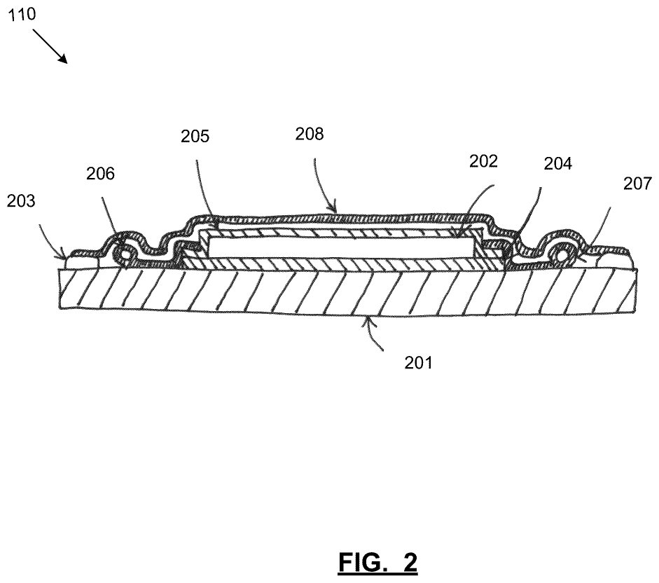

Referring now to FIG. 2, shown therein is a diagram of the solvent infusion system 110. In one embodiment, a tooling surface, such as a mold 201, can be used in the process to help support the composite polymer object being broken down, however it is optional. In one embodiment, the composite polymer object can be placed into the flexible bag 208 without the mold. In one embodiment, a mold 201 can be custom made for each composite polymer object to be recycled. A mold 201 can be made by covering the part to be recycled in a release film (i.e., silicone mold release, wax, packing tape, Teflon release film). The part to be recycled is herein referred to as “the part”.

Once the part is covered in release film, the mold 201 can be made directly on the part. The mold should be made of a material that is both resistant to the solvent, acids, or other harsh chemicals it may come into contact with as well as be able to withstand high temperatures for long durations. Examples of mold materials include, but are not limited to: fiberglass, PTFE, vinylester and polyurethane. The fiberglass may optionally be embedded with epoxy, polyester or vinylester to increase the strength of the mold material.

The composite polymer object can include any object composed of a reinforcing phase (also referred to as embedded object phase, or embedded fiber phase) embedded in a resin matrix phase. The reinforcing phase may be composed of synthetic materials, natural materials, or combinations thereof. The resin matrix phase may be composed of polymers, metals, ceramics, or combinations thereof. The composite polymer object can be prepared by a method including, for example: wet lay-up, vacuum infusion, filament winding, and/or resin transfer molding.

The reinforcing phase can be composed of a variety of materials, including single materials or combinations thereof, including: carbon fibers, carbon nanotube fibers, aramid fibers, glass fibers, boron fibers, basalt fibers, high-modulus polyethylene fibers, poly p-phenylene-2,6-benzobisoxazole fibers, quartz fibers, ceramic fibers, stainless steel fibers, titanium fibers, copper fibers, nickel fibers, metal coated fibers (e.g., coated with silver, gold, ruthenium, alloys, etc.), natural fibers and mineral fibers. The fibers may include only a single material phase (e.g., fibers composed of a single, uniform material) or may be multi-phasic structures (e.g., metal coated fibers including a core of one material phase and different metal coating material phase). Such fibers will typically have a diameter in a micro-size range (e.g., 100 microns or smaller) or even a nano-size range (e.g., smaller than one micron). The reinforcing phase can be composed of materials of a particulate, fiber, or network architecture.

The resin matrix phase can be composed of polymers such as thermosets, thermoplastics, elastomers, or combinations thereof. Some embodiments may include uncured thermoset compositions, for example including epoxy resins, phenolic resins, polyester resins, unsaturated polyesters, polyimide resins, polyimine resins, polyurethane resins, vinyl esters, cyanate esters, bismaleimides, benzoxazines, phthalonitriles, polybutadiene, and combinations thereof. Some embodiments may include cured thermoset compositions, including those made from the uncured thermoset compositions, and for example including recyclable or cleavable resin systems. Some embodiments may include thermoplastics, for example polyolefins (e.g., including polyethylene, polypropylene and/or propylene-ethylene copolymers), polyethylene terephthalates (PET), polybutylene terephthalates (PBT), polycarbonates, acrylonitrile butadiene styrenes (ABS), polyamides, polyetheretherketones (PEEK), polyetherketones (PEK), polyamide-imides, polyarylsulfones, polyetherimides (PEI), polyethersulfones, polyphenylene sulfides, liquid crystal polymers, cyclic thermoplastic polyesters, and combinations thereof.

FIG. 2 shows a diagram of the solvent infusion system 110. A simplified, square flat part 202 is shown as an example, however it can be appreciated that more complex and larger parts can be recycled in the same process. An inlet feed line 206 and an outlet feed line 207 can be cut to the same length and placed on either side of the part, parallel to each other. The inlet feed line 206 can allow the solution to be injected into a closed flexible bag 208 and the outlet feed line 207 can pull the solution out of the flexible bag 208. In one embodiment, the inlet feed line 206 and outer feed line 207 are connected to an inner feed line. The inner feed line provides the solution to the composite polymer object. In one embodiment, the inner feed line comprises spiral tubing, which has gaps for the solution to escape the tubing. The inner feed line can be connected to the tubing outside of the solvent infusion system 110. The inner feed line can have a quick connect shutoff valve installed to allow quick shutoff of the solvent infusion system 110 from the remaining system 100. Once the shutoff valves are installed, the flexible bag 208 can be placed and sealed on the part 202.

In one embodiment, a polyethylene flexible bag can be used for its resistance to acids such as acetic acid. If a harsher chemical were to be used, it would be suggested to use Teflon bagging film for its excellent resistance to chemicals. The flexible bag chosen can be re-useable and/or re-sealable. In at least one embodiment, the flexible bag includes a feed line welded or otherwise positioned therein to improve set-up times and efficiencies. Further embodiments can include flexible bags composed of polyethylene (PE), crosslinked polyethylene (XLPE), polypropylene (PP), polyamides like polyamide (PA) and polyamide-6 (PA-6), fluoropolymers like polytetrafluoroethylene (PTFE), perfluoroalkoxy alkanes (PFA), polyvinylidene fluoride (PVDF), polyvinyl fluoride (PVF), fluorinated ethylene propylene (FEP), and ethylene tetrafluoroethylene (ETFE).

The flexible bag 208 can then be sealed. In one embodiment, sealant tape 203 can be applied to the outside perimeter of the flexible bag 208. In one embodiment, the edges of the flexible bag 208 can be heat-sealed. Heat-sealing can be done by cutting two sheets of polyethylene (or nylon) plastic the same size and melting the two pieces together around the perimeter with a hot iron or the like. The part to be recycled and the flow media can be placed on top of one oversize plastic sheet and then the other sheet can be draped over top and the perimeter hot melted together. Another way this can be achieved is by hot melting the edges of the flexible bag 208, but leaving an opening to place the part inside and then sealing the opening afterward. The feed lines for the solution can be connected inside the hot melted perimeter and sealed using sealant tape. In one embodiment, the feed line connectors can be built into the bag 208. The flexible bag material should ideally be resistant to the solvent being used and the temperature range required. The heat-seal should also be resistant to the solvent being used and the temperature range required.

A rigid spacer, or spacer layer, can be used to keep the flexible bag away from (spaced apart from) the composite polymer object. In one embodiment, the rigid spacer or spacer layer, can comprise a flow netting contacting a surface of the composite polymer object for facilitating contact or flow of the solvent around the polymer object.

Flow netting, or infusion media, can be used to help facilitate even flow around the entire composite polymer object being recycled. Flow media is a designed plastic mesh typically used in resin infusion manufacturing processes. It is chemical resistant, able to withstand high temperatures and can be reused.

A first layer of spacer layer, such as a flow netting 204 can be first placed on the mold surface, ensuring the perimeter is cut slightly larger than the part 202, and cut slightly smaller than the outer edge of the mold 201. Tape can be used on the edges of the flow media to help keep the mesh in place. The part 202 can then be placed on top of the flow media and a second, subsequent spacer layer, such as a layer of flow netting 205 can be placed on top of the part 202. The second layer of flow media can be cut to the same dimensions as the first layer 204. Having a plurality of flow media lays can help ensure that the part 202 is enclosed in flow media and therefore aid in the solvent solution to be circulated around the entire part 202.

In another embodiment, the rigid spacer, or spacer layer, can comprise a plurality of bosses coupled to the flexible bag that contacts a surface of the composite polymer object for facilitating contact or flow of the solvent around the polymer object.

The thickness of the rigid spacer, such as the flow netting or the bosses, can determine the thickness of the solvent solution being circulated over the polymer object or part. For instance, a thicker spacer can allow a thicker solvent layer to flow through and a thinner spacer layer can allow a thinner solvent layer to flow through and contact the polymer object. a thicker layer of mesh would hold more solvent. As the resin in the polymer object is removed from the first layers of the polymer object, the fibers (i.e. glass fibers or other fibers, fillers, etc.) can act as the spacer layer and carry the solvent through. So as the polymer object breaks down, the system becomes more effective because more solvent runs through the composite materials as the resin is removed from each layer.

In the setup process, a zoning method can be used to isolate specific areas of a large composite part. The zoning method can be used to isolate areas of a composite part that have varying thicknesses. For example, if a thinner area of the composite part has been broken down before a thicker area, the solvent or acid flow over the thinner area may be reduced or completely stopped. At the same time, circulation of solvent or acid can be isolated to the thicker area. The application of heat or pressure can also be isolated to specific areas of the composite polymer object. The zoning, or isolation can be achieved by creating a flow break between the areas of the composite polymer object desired to be isolated. A flow break can be achieved by only putting flow netting where circulation is needed and having, for instance, a 2-5 inch break where the flexible bag is in direct contact with the composite polymer object. The break can slow down circulation enough to allow the solution to only flow in the area that the flow netting is placed and the feed lines are opened. Once the composite polymer object in the zoned area has been broken down, the feed lines in that zone can be closed and the feed lines in the next zone can be opened to circulate the solution. Feed lines 206, 207 can be used to allow the solvent solution to flow into and exit the closed flexible bag 208 once the part 202 is under vacuum by the positive displacement pump 108. The feed lines can be made up of polyethylene spiral tubing. In one embodiment, ½″ diameter tubing is used but it is possible to use different diameter tube, depending on the size and complexity of the part 202 to be recycled. The spiral tube can be wrapped in a plastic mesh or porous film to improve flow and to prevent the flexible bag 208 from getting carried into the line once a vacuum is pulled from the positive displacement pump 108.

The feed lines 206, 207 can be placed on the flow media layers 204, 205, on either side of the part. The feed lines 206, 207 should be placed directly on top of both layers the flow media layers 204, 205. If the feed line is placed only touching the top layer of the flow media, it is possible that the solvent solution will only flow on top of the part 202 and not underneath.

In some cases, the flexible bag may be porous to solvent vapors, meaning that some solvent vapors can escape the flexible bag during the recycling process. To help extract any solvent/acid vapour that may migrate through the flexible bag during the breakdown process, a second, or subsequent flexible bag can be added to the set-up. This can be done by covering the bagged composite part with breather fabric (to help maintain adequate air removal), installing an outlet fitting in contact with the breather fabric and then applying a second sealed bag is over top of the bagged composite part. Any fittings installed on the bagged part can be passed through the second flexible bag and sealed with sealant tape. A positive displacement pump can be attached to the outlet fitting via a tube, such as a polyethylene or Teflon tube. The positive displacement pump can then be turned on, removing any air between the first and second bag. As a result, any vapour that escapes from the first bag will be isolated and evacuated with the positive displacement pump.

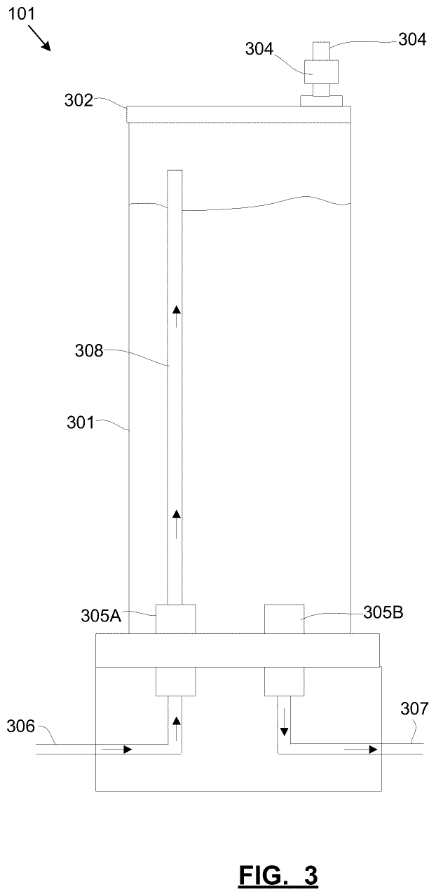

Referring now to FIG. 3, shown therein is a diagram of the first reservoir 101. The tank 301 of the first reservoir 101 can be constructed of and/or coated with a material which is chemically resistant, examples including: polyethylene (PE), crosslinked polyethylene (XLPE), polypropylene (PP), polyamides like polyamide (PA) and polyamide-6 (PA-6), fluoropolymers like polytetrafluoroethylene (PTFE), perfluoroalkoxy alkanes (PFA), polyvinylidene fluoride (PVDF), polyvinyl fluoride (PVF), fluorinated ethylene propylene (FEP), and ethylene tetrafluoroethylene (ETFE), and other materials such as fiberglass, vinylester resin, epoxy resin, polyester resin, and 300-series stainless steel. A lid 302 can be used to seal the top of the tank 301, which can optionally be clear, for example made of clear acrylic, or contain a sight glass for viewing into the tank 301. A check valve 303, with an air filter 304, can be attached to the lid 302 to allow for filling the tank 301 without any pressure buildup. Two fittings 305 are attached to the bottom of the tank 301. Fittings of the invention, including fittings 305, can be constructed of and/or coated with a material which is chemically resistant, examples including: polyethylene (PE), crosslinked polyethylene (XLPE), polypropylene (PP), polyamides like polyamide (PA) and polyamide-6 (PA-6), fluoropolymers like polytetrafluoroethylene (PTFE), perfluoroalkoxy alkanes (PFA), polyvinylidene fluoride (PVDF), polyvinyl fluoride (PVF), fluorinated ethylene propylene (FEP), and ethylene tetrafluoroethylene (ETFE), and 300-series stainless steel. One fitting 305A can connect to the inlet line 306 coming from the solvent infusion system 110 and a second fitting 305B can connect to the outlet line 307 going to the circulation pump 109. Any inlet and outlet lines of the invention, such as inlet line 306 and/or outlet line 307, can be constructed of and/or coated with a material which is chemically resistant, examples including: PTFE, fiberglass, vinylester resin, and 300-series stainless steel The inlet line 306 can extend into the tank 301 with an attached standing tube 308 that can reach near the top of the tank 301. The standing tube 308 can help relieve any back pressure that may occur onto the solvent infusion system 110.

The inlet 306 can be connected to the circulating pump 109 that draws from the second reservoir 102 in the set-up. The inlet line 306 can be connected to the tank to add any volume to the tank 301 as needed. A float switch can also be connected to the circulating pump 109 in order monitor volume and automate the filling procedure. The outlet line 307 can be connected flush with the bottom of the tank 301 to ensure adequate drainage.

Referring now to FIG. 4, shown therein is a diagram of the second reservoir 102. The second reservoir 102 comprises a tank 401 that can be constructed of and/or coated with a material which is chemically resistant, examples including: PTFE, fiberglass, vinylester resin, and 300-series stainless steel. The tank 401 can comprise a lid 402 that is not completely sealed, accommodating pressure differentials within the system. An inlet line 404, an outlet line 405, and a heater 403 pass through the lid 402 at the top of the tank 401. To help circulate the solvent solution in the tank, the inlet line can extend down near bottom of the tank 401. The inlet line 404 can be connected to the second reservoir 102 for isolated metering of the solvent solution to the system 100. The inlet 404 of the second reservoir 102 can be connected to a metering pump 105 that draws a solvent from the solvent reservoir 103.

The outlet line 405 can be placed near the top of the tank 401. The outlet line 405 can be connected to the second reservoir 102 for removal of the solvent solution from the tank 401 for overflow prevention. The outlet line 405 can be connected to the transfer pump 106 that draws excess solution from the tank 401 to a transfer container 104. A float switch could be connected to the transfer pump 104 in order monitor the volume of the tank 401 and automate the emptying procedure.

To heat the acidic or solvent solution, a submersible heater 403 is placed within the tank 401. In one embodiment, a submersible Teflon coated heater can be used to heat the second reservoir 102; but any suitable method of heating the tank 401 can be used. The heater can have the capacity to safely reach the temperature needed for the duration of time needed to breakdown the composite polymer object (anywhere from 1 hr to 1 week). In one embodiment, the reservoir can be heated to a temperature of about 80° C. A temperature controller 407 can be connected to the heater 403 to control the temperature of the heater. In one embodiment, the temperature controller 407 can be set-up with a 2° C. differential so the heater can maintain the optimum temperature without running the entire time.

In another embodiment, the acidic or solvent solution could be efficiently heated with radiant water, limiting the amount of solvent used in the process. Radiant water heating can be achieved by placing the solvent in a small tank that is submerged in a larger tank full of water that is heated to the desired temperature. In another embodiment, hot water tubing can be plumbed into the solvent tank and use a separate larger heated water supply tank. The hot water can then circulate in the pipework and heat the solvent or acid solution to the desired temperature. In this embodiment, a minimum amount of solvent is required and the water would provide the appropriate amount of thermal mass to efficiently heat a large part.

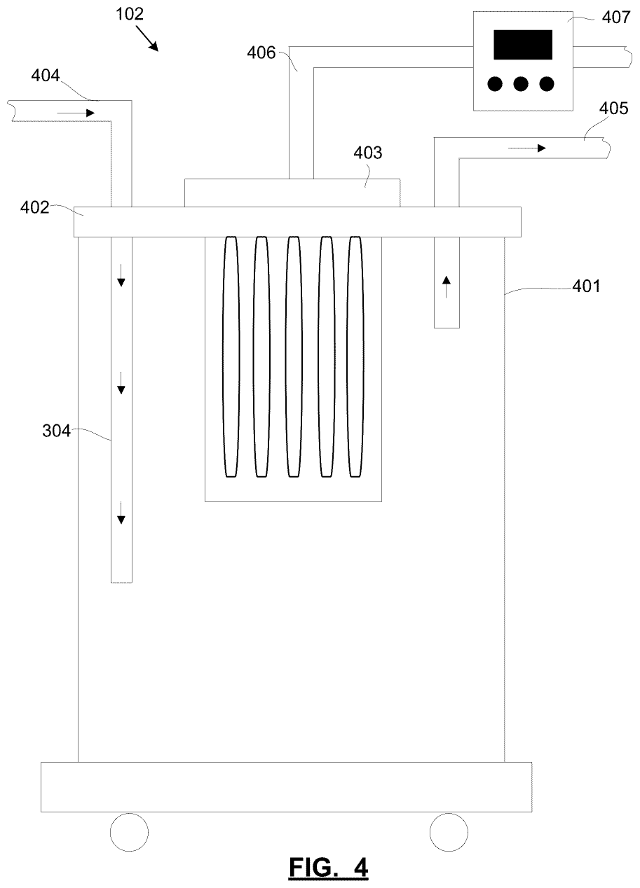

Turning now to FIG. 5, which provides a flow chart showing a method of recycling a material according to one embodiment. In one embodiment, the method comprises: providing a composite polymer object at step 510. At step 520, the composite polymer object is contacted with flow netting. At step 530, a vacuum cover or bag is sealed outside of the flow netting and the composite polymer object. At step 540, solvent is flowed into the flexible bag through an inlet feed line fluidly connected to the flexible bag. The solvent solution can circulates along the surface of the composite polymer object and separates embedded components from the polymer matrix part. At step 550, the embedded component are removed from the polymer matrix part.

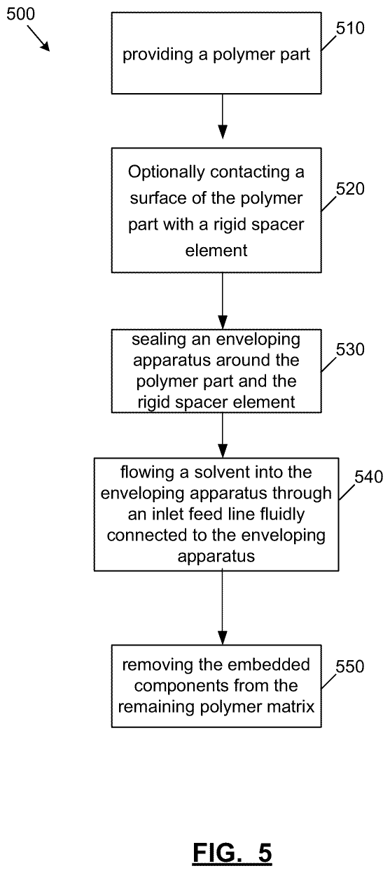

Turning now to FIG. 6, which provides a flow chart showing a method of recycling a material according to another embodiment. In one embodiment, the method comprises: at step 610, sealing the composite polymer object inside a flexible bag, the composite polymer object comprising a polymer matrix component and embedded component. At step 620, circulating a solvent through the flexible bag, the solvent having a chemical reaction with the composite polymer object that frees the embedded component from the polymer matrix component, the flexible bag being degradation resistant to the solvent. At step 630, recovering the embedded component from the polymer matrix.

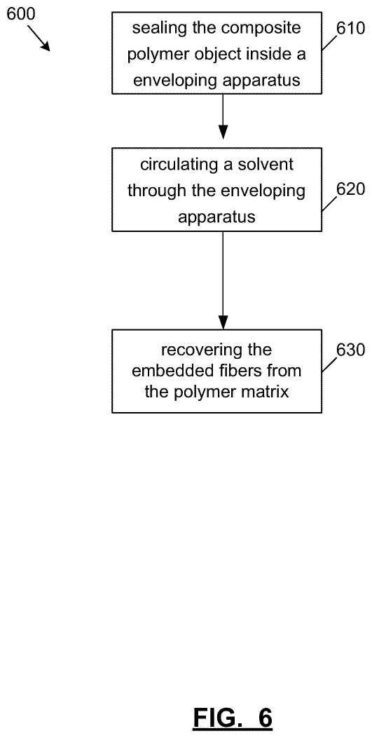

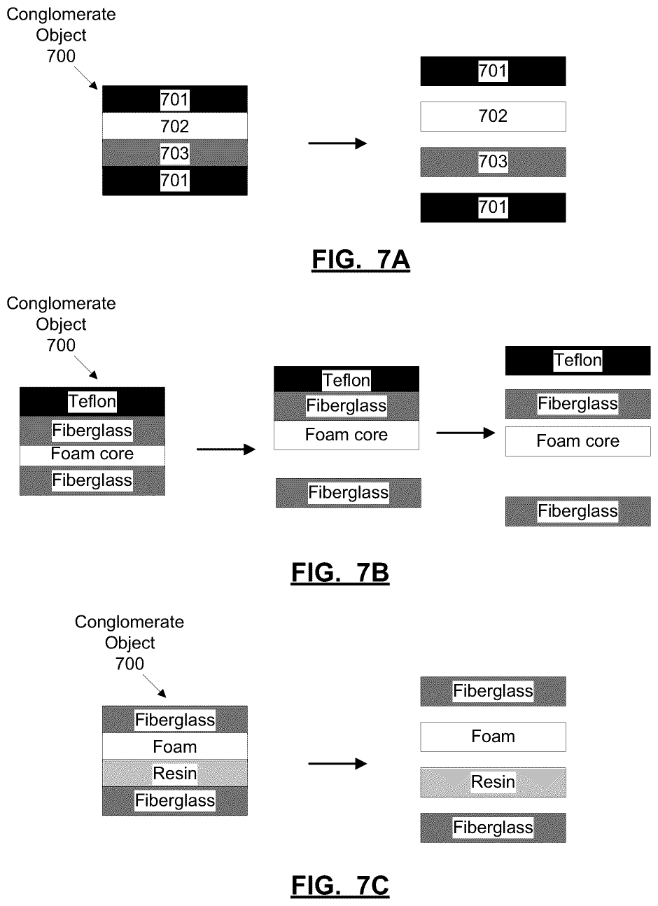

Turning now to FIGS. 7A to 11C, which provide various embodiments of the polymer separation method. FIG. 7A is a block diagram showing an embodiment of the input and output of the recycling system. In this embodiment, a conglomerate object 700 is shown, have a stack of four objects, comprising 3 materials 701, 702, and 703. A solvent may be chosen such that the four objects of the conglomerate object 700 are cleaved or separated. Optionally, a variety of solvents may be needed to cleave or separate the four objects of the conglomerate object.

FIG. 7B is a block diagram showing an embodiment of the input and output of the recycling system. In this embodiment, a conglomerate object 700 is shown, have a stack of four objects, comprising Teflon, fiberglass and foam core. In this embodiment, a variety of solvents may be needed to cleave the four objects of the conglomerate object. The recycling process may be done in multiple rounds to separate the four objects of the conglomerate object. For instance, the fiberglass can be separated first, followed by another round to separate the Teflon, Fiberglass and foam core.

FIG. 7C is a block diagram showing an embodiment of the input and output of the recycling system; In this embodiment, a conglomerate object 700 is shown, having a stack of four objects, comprising fiberglass, foam, resin and fiberglass. In this embodiment, a variety of solvents may be needed to cleave the four objects of the conglomerate object. The recycling process may be done in multiple rounds to separate the four objects of the conglomerate object.

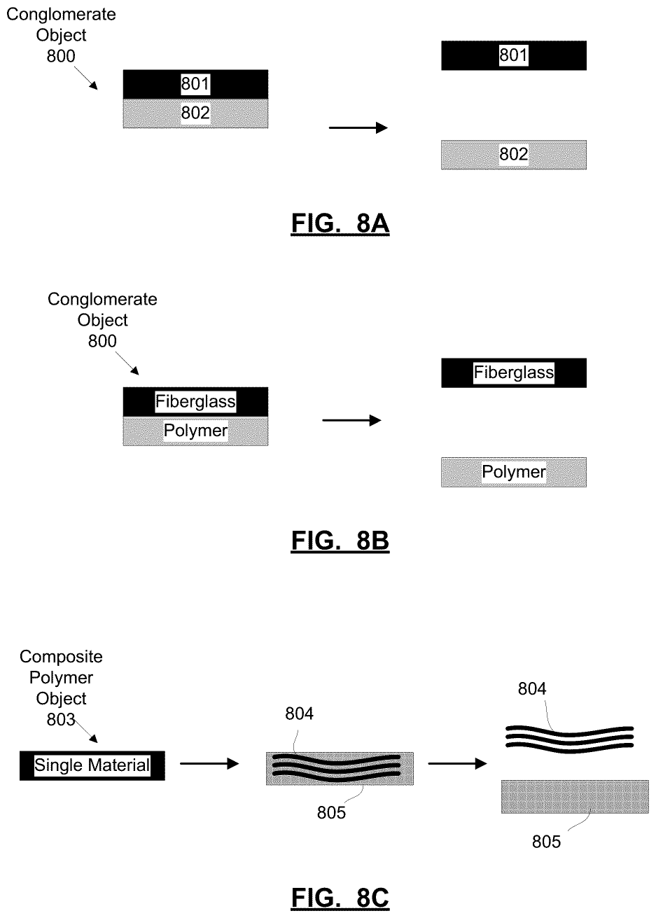

FIG. 8A is a block diagram showing an embodiment of the input and output of the recycling system. In this embodiment, a conglomerate object 800 is shown, having a stack of two objects, comprising two materials 801 and 802. Materials 801 and 802 may be chemically boned together. A solvent may be chosen such that the two objects, and two materials of the conglomerate object can be cleaved or separated.

FIG. 8B is a block diagram showing an embodiment of the input and output of the recycling system. In this embodiment, a conglomerate object 800 is shown, having a stack of two objects, comprising fiberglass and polymer materials, which may be chemically boned together. A solvent may be chosen such that the two objects of the conglomerate object are cleaved or separated.

FIG. 8C is a block diagram showing an embodiment of the input and output of the recycling system. In this embodiment, a composite polymer object 803 is shown. A composite polymer object 803 refers to an embedded component (such as fibers or fillers) and a polymer matrix component (such as resin). The embedded component 804 and polymer matrix component 805 can be initially chemically or physically bonded. A solvent can be reacted with the composite polymer object 803 such that a chemical reaction between the solvent and the composite polymer object can free the embedded component 804 from the polymer matrix component 805.

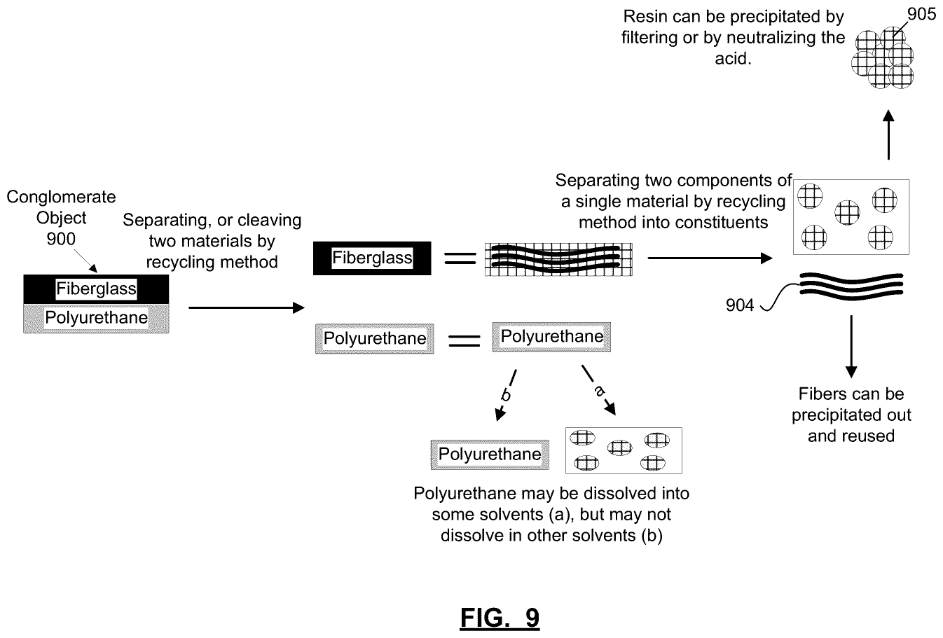

FIG. 9 is a block diagram showing an embodiment of the input and output of the recycling system. In this embodiment, a conglomerate object 900 is shown, having a stack of two objects, comprising fiberglass bonded with polyurethane, which may be chemically boned together. A solvent may be chosen such that the two objects of the conglomerate object are cleaved or separated. The fiberglass (which is a composite polymer object) can then be separated further. A solvent can be reacted with the composite polymer object (fiberglass) such that a chemical reaction between the solvent and the composite polymer object can free the embedded component 904 from the polymer matrix component 905. The Polyurethane may be dissolved into some solvents (a), but may not dissolve in other solvents (b); so a solvent which dissolves polyurethane can be chosen accordingly.

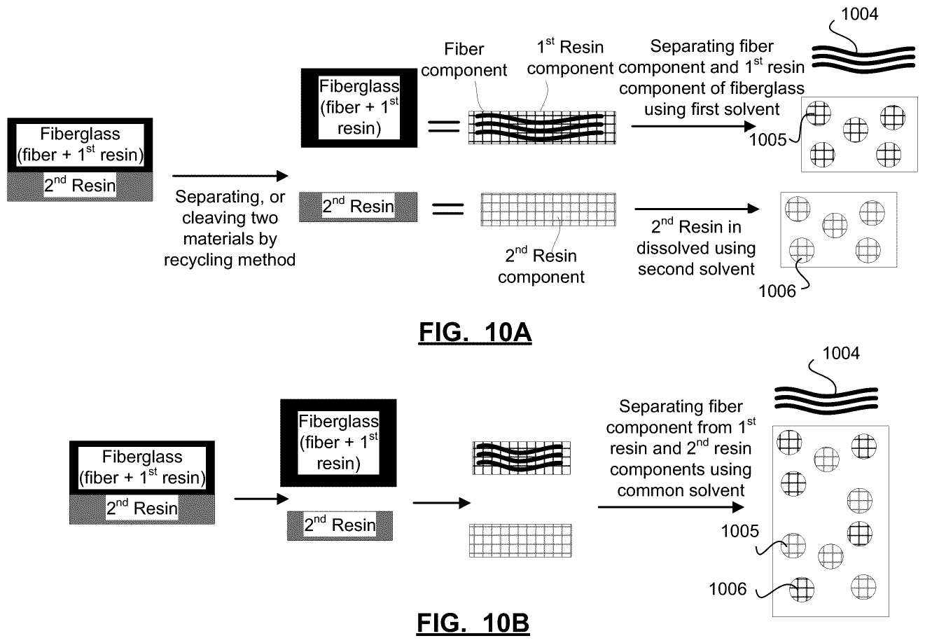

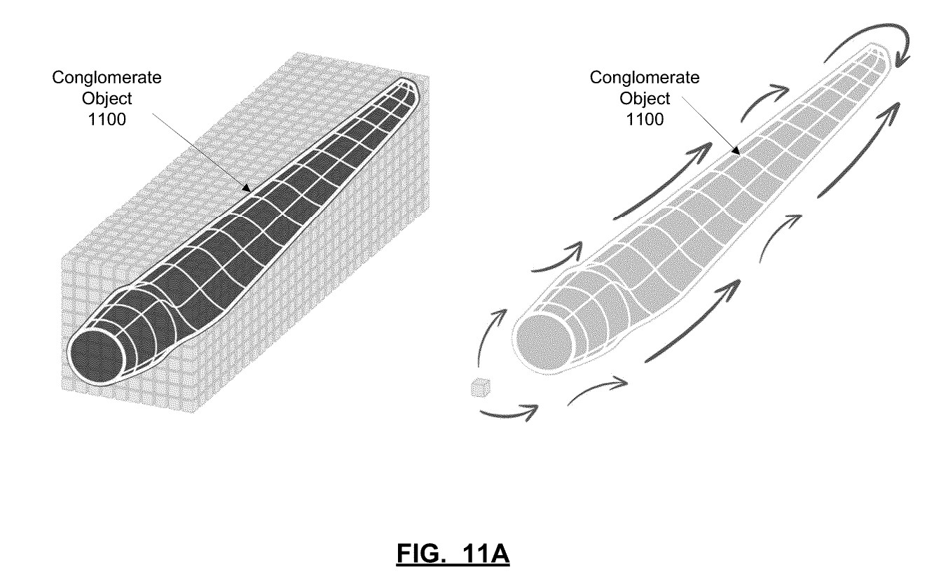

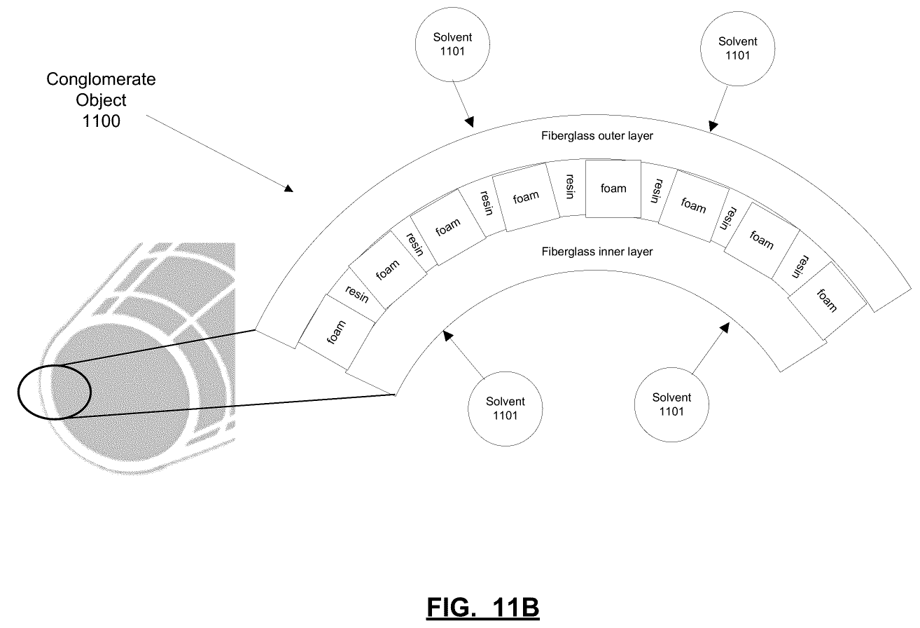

FIG. 10A is a block diagram showing an embodiment of the input and output of the recycling system. Here, two separate solvents can be used to dissolve the polymer matrix component or each of the objects of the conglomerate object. A solvent can be reacted with the fiberglass object such that a chemical reaction between the solvent and the composite polymer object can free the embedded component 1004 from the polymer matrix component 1005. The resin matrix materials can be dissolved using a plurality of solvents.

FIG. 10B is a block diagram showing an embodiment of the input and output of the recycling system. A common solvent may be used to dissolve the matrix component of each of the fiberglass and 2^{nd} resin matrix materials. A solvent can be reacted with the fiberglass object such that a chemical reaction between the solvent and the composite polymer object can free the embedded component 1004 from the polymer matrix component 1005 and 1006. The resin matrix materials can be dissolved using a solvent common to the 1^{st} and 2^{nd} resin components.

FIGS. 11B, 11C and 11D provide a block diagram showing the process of a conglomerate object 1100 being dissolved by a solvent. In this embodiment, the conglomerate object comprises a resin and foam layer, sandwiched between a fiberglass inner and fiberglass outer layer. A first solvent 1101 can be flowed through the surface of the material to dissolve the inner and outer fiberglass layers simultaneously. In FIG. 11C, a second solvent 1102 can be flowed through the material to dissolve the resin component. In FIG. 11D, a third solvent 1103 can be flowed through the material to dissolve the foam component. This process can separate or otherwise recycle a conglomerate object into its constituent parts. This process can also separate or otherwise recycle a composite polymer object such as fiberglass into its constituent parts. The process of recycling the conglomerate object prior to separating the composite polymer object can help reduce of avoid contamination from the conglomerate object into the composite polymer objects. As such, a first solvent can be chosen such that the first solvent dissolves a first material of the conglomerate object, but does not dissolve the remainder of the conglomerate object. Once the first material is separated from the conglomerate object by the first solvent, a second solvent can be chosen such that the second solvent dissolves the second material from the conglomerate object. The process can be repeated until all the materials of the conglomerate object are separated. Once the conglomerate object is separated into its constituent parts, the process can be repeated to separate the constituent parts (which can include composite polymer objects) into the fiber component and resin components. The fiber and resin components can therefore have reduced contamination since the conglomerate polymer object was separated first.

The composite polymer object can include any object composed of an embedded fiber phase in a resin matrix phase. The embedded fiber phase may be composed of synthetic materials, natural materials, or combinations thereof. The fibers can further be oriented in a various orientations or architectures to enhance their strengthening, optical, magnetic or other properties. FIG. 12 depicts various architectures of embedded fiber objects. Some embodiments may include particulate architectures including nanocomposites or microcomposites. Some embodiments may include fiber architectures of a continuous nature, such as longitudinal unidirectional (1201), transverse unidirectional (1202), biaxial (1203, 1204), double bias, bidirectional, longitudinal triaxial, transverse triaxial (1205), quadraxial (1206), multidirectional, woven (1207), or mat fibers. Some embodiments may include fiber architectures of a discontinuous nature, such as aligned short fibers or random short fibers. Some embodiments may include network architectures such as honeycomb or open cell structures. In multidirectional fiber systems, the fibers can intersect the resin system at an angle such as 0°, ±30°, ±45°, ±60°, and/or ±90°.

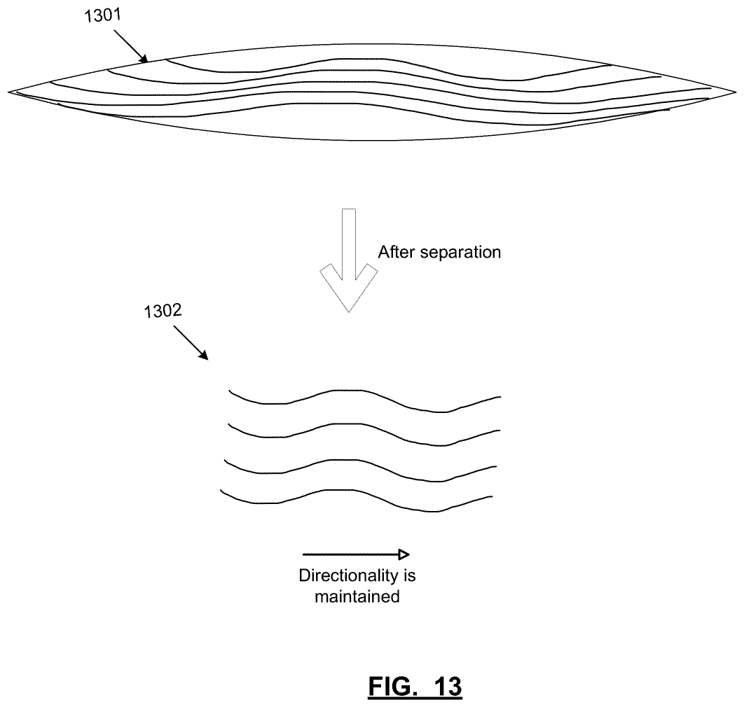

Composite polymer objects can also include objects and portions of objects including, but not limited to: boat hulls, automotive parts, large furniture items, bathtubs, gas tanks such as hydrogen and oxygen tanks, windmill blades, aircraft parts such as wings, and/or fuselage. As shown in FIG. 13, larger structures such as windmill blades are composed of fibers which often have directionality (1301). After the separation of the invention, these fibers retain their directionality (1302). For instance, longitudinal unidirectional can remain in a longitudinal unidirectional directionality, transverse unidirectional can remain in a transverse unidirectional directionality, biaxial fibers can retain biaxial directionality, etc.

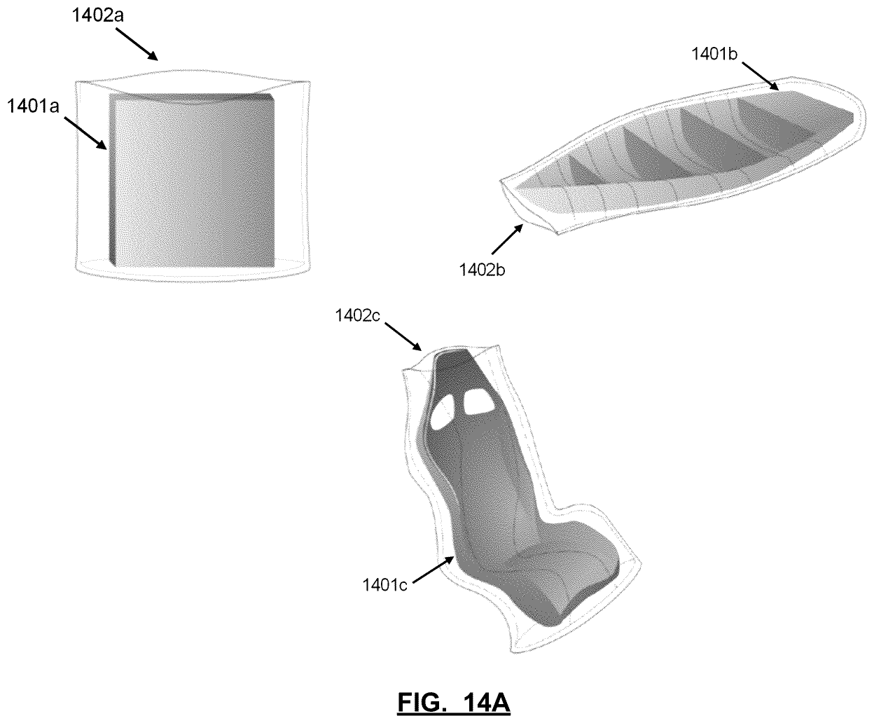

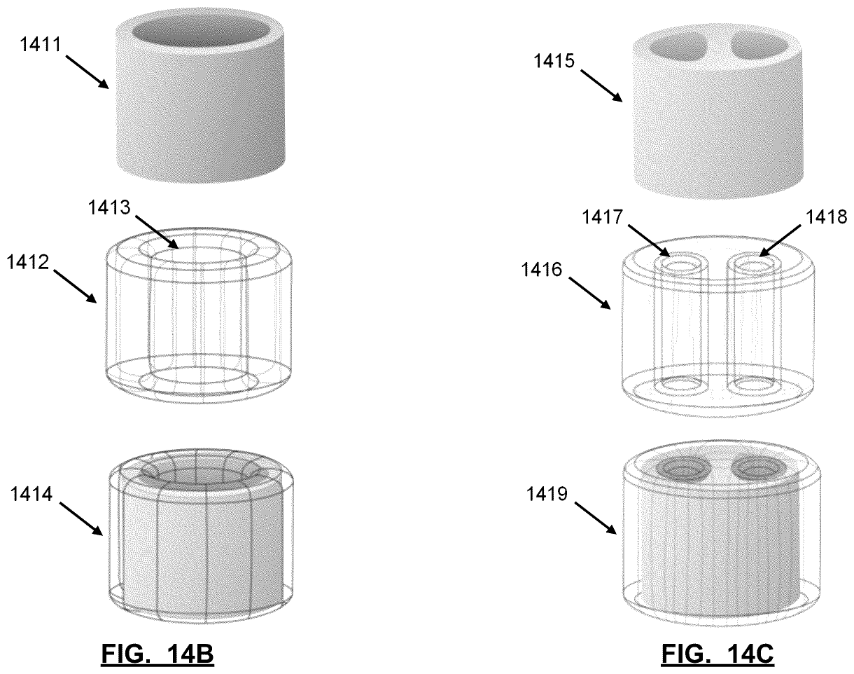

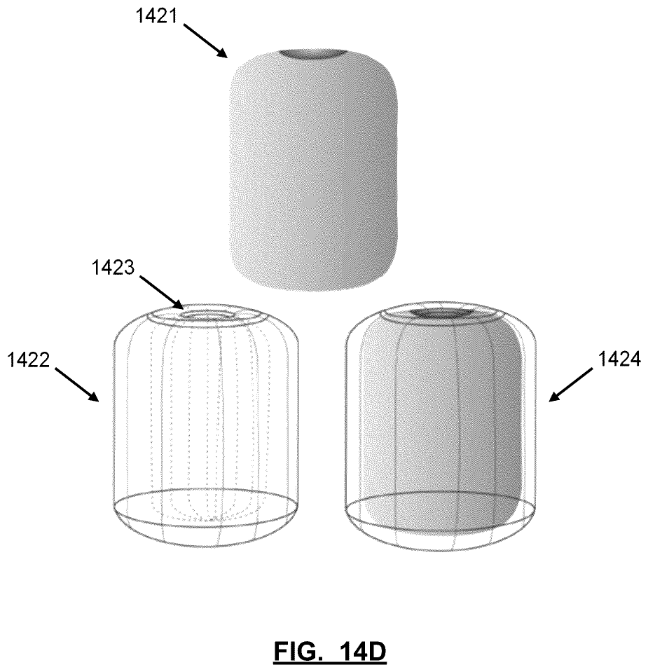

Turning now to FIGS. 14A to 14D, which provide various exemplary embodiments of the recycling system. FIG. 14A depicts composite polymer objects (1401a, 1401b, 1401c) to be recycled, situated inside of envelopes (1402a, 1402b, 1402c) in an open configuration. FIG. 14B depicts a hollow composite polymer object with a single continuous opening (1411), a contouring bag (1412) with a single continuous opening (1413) which is designed to outline the interior and exterior surface area and shape of the hollow composite polymer object, and a hollow composite polymer object inside of a contouring bag (1414). FIG. 14C depicts a hollow composite polymer object with two discrete continuous openings (1415), a contouring bag (1416) with two discrete continuous openings (1417, 1418) which is designed to outline the interior and exterior surface area and shape of the hollow composite polymer object, and a hollow composite polymer object inside of a contouring bag (1419). FIG. 14D depicts a hollow composite polymer object with one discontinuous opening (1421), a contouring bag (1422) with one discontinuous openings (1423) which is designed to outline the interior and exterior surface area and shape of the hollow composite polymer object, and a hollow composite polymer object inside of a contouring bag (1424).

While the applicant's teachings described herein are in conjunction with various embodiments for illustrative purposes, it is not intended that the applicant's teachings be limited to such embodiments. On the contrary, the applicant's teachings described and illustrated herein encompass various alternatives, modifications, and equivalents, without departing from the embodiments, the general scope of which is defined in the appended claims.

### ITEMS

Item 1: A method for recycling a composite polymer object, the method comprising: sealing the composite polymer object inside a flexible bag, the composite polymer object comprising a polymer matrix component (such as bitumers, thermo-set, polymer substrate, resin) and embedded component (such as fibers, fillers, wood, glass etc); circulating a solvent through the flexible bag, the solvent having a chemical re-action with the composite polymer object that frees the embedded component from the polymer matrix component, the flexible bag being degradation resistant to the solvent; and recovering the embedded component from the polymer matrix component.
Item 2: A method for recycling a composite polymer object, the method comprising: sealing the composite polymer object inside an envelope, the composite polymer object comprising a polymer matrix component (such as bitumers, thermo-set, polymer substrate, resin) and embedded component (such as fibers, fillers, wood, glass etc); circulating a solvent through the envelope, the solvent having a chemical re-action with the composite polymer object that frees the embedded component from the polymer matrix component, the envelope being degradation resistant to the solvent; and recovering the embedded component from the polymer matrix component.
Item 3: A method for recycling a composite polymer object, the method comprising: sealing the composite polymer object inside a contouring bag or contouring film, the composite polymer object comprising a polymer matrix component (such as bitumers, thermo-set, polymer substrate, resin) and embedded component (such as fibers, fillers, wood, glass etc); circulating a solvent through the contouring bag or contouring film, the solvent having a chemical re-action with the composite polymer object that frees the embedded component from the polymer matrix component, the contouring bag or contouring film being degradation resistant to the solvent; and recovering the embedded component from the polymer matrix component.
Item 4: The method of any preceding item, further comprising a rigid spacer to keep the flexible bag or envelope or contouring bag or contouring film away from the composite polymer object.
Item 5: The method of any preceding item, wherein the rigid spacer comprises a flow netting contacting a surface of the composite polymer object for facilitating contact or flow of the solvent around the polymer object.
Item 6: The method of any preceding item, wherein the rigid spacer comprises a plurality of bosses coupled to the flexible bag or envelope or contouring bag or contouring film that contacts a surface of the composite polymer object for facilitating contact or flow of the solvent around the polymer object.
Item 7: The method of any preceding item, further comprising: preparing a mold to support the polymer object.
Item 8: The method of any preceding item, further comprising: placing the poly-mer object within the mold; and sealing the flexible bag or envelope or contouring bag or contouring film outside of the polymer object, the flow netting; and the mold.
Item 9: The method of any preceding item, wherein sealing the flexible bag or envelope or contouring bag or contouring film comprises heat-sealing the flexible bag or envelope or contouring bag or contouring film around the polymer object using an iron.
Item 10: The method of any preceding item, wherein sealing the flexible bag or envelope or contouring bag or contouring film comprises sealing the flexible bag or envelope or contouring bag or contouring film around the polymer object using sealant tape.
Item 11: The method of any preceding item, wherein the flexible bag or envelope or contouring bag or contouring film comprises a first layer and a second layer, the first layer being placed on at least one surface of the polymer object; and the second layer being placed on at least another surface of the polymer object; such that a plurality of the surfaces of the polymer object are covered by the flexible bag or envelope or contouring bag or contouring film.
Item 12: The method of any preceding item, wherein said recovering the embedded fibers comprises removing the polymer substrate from the flexible bag or envelope or contouring bag or contouring film.
Item 13: The method of any preceding item, wherein said removing the polymer substrate from the flexible bag or envelope or contouring bag or contouring film comprises moving the polymer substrate to a waste storage container.
Item 14: The method of any preceding item, wherein said recovering the embedded fibers comprises removing the embedded fibers from the flexible bag or envelope or contouring bag or contouring film.
Item 15: The method of any preceding item, further comprising: flowing the solvent solution out of the flexible bag or envelope or contouring bag or contouring film through an outlet feed line. In one embodiment, there is an inlet, outlet and continuous flow through the system. In one embodiment, an amount of solvent is already loaded into the flexible bag or envelope or contouring bag or contouring film before vacuum is applied, after which the solvent is circulated through the system and flows through the fluidly connected outlet.
Item 16: The method of any preceding item, further comprising: flushing out the flexible bag or envelope or contouring bag or contouring film using water, solvent, or surfactant.
Item 17: A system for recycling a composite polymer object, the system comprising: a solvent flow path; a solvent reservoir fluid communication with, optionally in, the solvent flow path, the solvent reservoir containing solvent and having a solvent reservoir outlet, the solvent being degratively reactive with thermoset polymer; a flexible bag in the solvent flow path, the flexible bag having an object compartment, a solvent inlet fluidly connected to the object compartment, and a solvent outlet fluidly connected to the object compartment, the solvent inlet positioned down-stream of the solvent reservoir outlet; and a solvent circulation pump positioned in the solvent flow path in fluid communication with the solvent reservoir and the flexible bag.
Item 18: A system for recycling a composite polymer object, the system comprising: a solvent flow path; a solvent reservoir fluid communication with, optionally in, the solvent flow path, the solvent reservoir containing solvent and having a solvent reservoir outlet, the solvent being degratively reactive with thermoset polymer; a flexible envelope in the solvent flow path, the envelope having an object compartment, a solvent inlet fluidly connected to the object compartment, and a solvent outlet fluidly connected to the object compartment, the solvent inlet positioned down-stream of the solvent reservoir outlet; and a solvent circulation pump positioned in the solvent flow path in fluid communication with the solvent reservoir and the envelope.
Item 19: A system for recycling a composite polymer object, the system comprising: a solvent flow path; a solvent reservoir fluid communication with, optionally in, the solvent flow path, the solvent reservoir containing solvent and having a solvent reservoir outlet, the solvent being degratively reactive with thermoset polymer; a flexible contouring bag or contouring film in the solvent flow path, the contouring bag or contouring film having an object compartment, a solvent inlet fluidly connected to the object compartment, and a solvent outlet fluidly connected to the object compartment, the solvent inlet positioned down-stream of the solvent reservoir outlet; and a solvent circulation pump positioned in the solvent flow path in fluid communication with the solvent reservoir and the contouring bag or contouring film.
Item 20: The system of any preceding item, wherein the solvent reservoir further comprises a heating element for heating the solvent in the solvent reservoir.
Item 21: The system of any preceding item, further comprising a rigid spacer positioned in the flexible bag or envelope or contouring bag or contouring film to keep the flexible bag or envelope or contouring bag or contouring film away from the composite polymer object.
Item 22: The system of any preceding item, wherein the rigid spacer comprises a flow netting contacting a surface of the composite polymer object for facilitating contact or flow of the solvent around the polymer object.
Item 23: The system of any preceding item, wherein the rigid spacer comprises a plurality of bosses coupled to the flexible bag or envelope or contouring bag or contouring film that contacts a surface of the composite polymer object for facilitating contact or flow of the solvent around the polymer object.
Item 24: The system of any preceding item, further comprising: preparing a mold to support the polymer object.
Item 25: The system of any preceding item, wherein the mold is composed of at least one of the following: fiberglass, PTFE, vinylester and polyurethane.
Item 26: The system of any preceding item, wherein the system further comprises a positive displacement pump coupled to the solvent inlet of the flexible bag or envelope or contouring bag or contouring film for providing a vacuum to the system.
Item 27: The system of any preceding item, wherein the system further comprises a catch pot coupled to the positive displacement pump for preventing the positive displacement pump from taking in fluids from the system.
Item 28: The system of any preceding item, wherein the system further comprises a metering pump fluidly coupled to the solvent reservoir for providing a metered amount of solvent to the solvent reservoir to prepare a solvent solution in the solvent reservoir.
Item 29: The system of any preceding item, wherein multiple solvents are combined in the solvent reservoir.
Item 30: The system of any preceding item, wherein the system further comprises a transfer pump coupled to the second reservoir for transferring excess solution out of the second reservoir.
Item 31: The system of any preceding item, wherein the system further comprises a transfer container coupled to the transfer pump for containing the excess solution from the second reservoir.
Item 32: The system of any preceding item, wherein the system further comprises a priming reservoir containing an aqueous solution for priming the system and the solvent flow path.
Item 33: The system of any preceding item, wherein the priming reservoir passes water through the entire system so that the water can push air out of the system to remove the air from the system prior to use.
Item 34: The system of any preceding item, wherein a polymer object is placed in the object compartment; and wherein the polymer object is a thermoset polymer.
Item 35: The system of any preceding item, wherein the polymer object is at least a portion of a boat, such as a boat hull, manufactured scrap material, (starting material can be anything: balsa wood, foam core, metal, polyurethane paint), or a windmill blade (lightning grounding materials from the polymer).
Item 36: A method for recycling a composite polymer object, the method comprising: sealing the composite polymer object inside a flexible bag, the composite polymer object comprising an embedded component (such as fibers or fillers) and a polymer matrix component (such as resin); wherein the embedded com-ponent and polymer matrix component are chemically bonded; circulating a solvent through the flexible bag, the solvent having a chemical reaction with the composite polymer object that frees the embedded component from the thermo-set polymer matrix component, the flexible bag being degradation resistant to the solvent; and recovering the embedded component from the polymer matrix com-ponent.
Item 37: A method for recycling a composite polymer object, the method comprising: sealing the composite polymer object inside an envelope, the composite polymer object comprising an embedded component (such as fibers or fillers) and a polymer matrix component (such as resin); wherein the embedded com-ponent and polymer matrix component are chemically bonded; circulating a solvent through the envelope, the solvent having a chemical reaction with the composite polymer object that frees the embedded component from the thermo-set polymer matrix component, the envelope being degradation resistant to the solvent; and recovering the embedded component from the polymer matrix com-ponent.
Item 38: A method for recycling a composite polymer object, the method comprising: sealing the composite polymer object inside a contouring bag or contouring film, the composite polymer object comprising an embedded component (such as fibers or fillers) and a polymer matrix component (such as resin); wherein the embedded com-ponent and polymer matrix component are chemically bonded; circulating a solvent through the contouring bag or contouring film, the solvent having a chemical reaction with the composite polymer object that frees the embedded component from the thermo-set polymer matrix component, the contouring bag or contouring film being degradation resistant to the solvent; and recovering the embedded component from the polymer matrix com-ponent.
Item 39: A method for recycling a conglomerate object, the method comprising: sealing the conglomerate object inside a flexible bag, the conglomerate object comprising at least a first object of a first material and a second object of a second material; wherein the first object and the second object are chemically bonded; circulating a solvent through the flexible bag, the solvent having a chemical reaction with at least one surface of the conglomerate object that cleaves the first object from the second object, the flexible bag being degradation resistant to the solvent; and recovering the first or second material from the flexible bag.
Item 40: A method for recycling a conglomerate object, the method comprising: sealing the conglomerate object inside an envelope, the conglomerate object comprising at least a first object of a first material and a second object of a second material; wherein the first object and the second object are chemically bonded; circulating a solvent through the envelope, the solvent having a chemical reaction with at least one surface of the conglomerate object that cleaves the first object from the second object, the envelope being degradation resistant to the solvent; and recovering the first or second material from the envelope.
Item 41: A method for recycling a conglomerate object, the method comprising: sealing the conglomerate object inside a contouring bag or contouring film, the conglomerate object comprising at least a first object of a first material and a second object of a second material; wherein the first object and the second object are chemically bonded; circulating a solvent through the contouring bag or contouring film, the solvent having a chemical reaction with at least one surface of the conglomerate object that cleaves the first object from the second object, the contouring bag or contouring film being degradation resistant to the solvent; and recovering the first or second material from the contouring bag or contouring film.
Item 42: The method of any preceding item, wherein the first object comprises a composite polymer object.
Item 43: The method of any preceding item, wherein the composite polymer object comprises an embedded component (such as fibers or fillers) and a polymer matrix component (such as resin).
Item 44: A method for creating one or more openings in a hollow composite polymer object, the method comprising: boring one or more openings through the hollow composite polymer object such that the interior surface area is accessible for a contouring bag or contouring film.
Item 45: A method for creating one or more openings in a conglomerate object, the method comprising: boring one or more openings through the hollow composite polymer object such that the interior surface area is accessible for a contouring bag or contouring film.

1. A method for recycling a composite polymer object, the method comprising:
sealing the composite polymer object inside a flexible bag fitted with an inlet feed line and an outlet feed line each fluidly connected to the flexible bag;
the composite polymer object comprising an embedded component, optionally fibers or fillers, and a polymer matrix component, optionally a resin;
wherein the embedded component and polymer matrix component are chemically bonded;
circulating a solvent through the flexible bag, the solvent having a chemical reaction with the composite polymer object that frees the embedded component from the polymer matrix component; and
recovering the embedded component from the polymer matrix component.

2. A method for recycling a conglomerate object, the method comprising:
sealing the conglomerate object inside a flexible bag,
the conglomerate object comprising at least a first object of a first material and a second object of a second material;
wherein the first object and the second object are chemically bonded;
circulating a solvent through the flexible bag, the solvent having a chemical reaction with at least one surface of the conglomerate object that cleaves the first object from the second object, the flexible bag being degradation resistant to the solvent; and
recovering the first or second material from the flexible bag.

3. The method of claim 2, wherein the first object comprises a composite polymer object and wherein the composite polymer object comprises an embedded component (such as fibers or fillers) and a polymer matrix component (such as resin).

4. The method of claim 1, further comprising placing a rigid spacer to keep the flexible bag away from the composite polymer object.

5. The method of claim 4, wherein the rigid spacer comprises at least one of:
a flow netting contacting a surface of the composite polymer object; and
a plurality of bosses coupled to the flexible bag that contacts a surface of the composite polymer object;
for facilitating contact or flow of the solvent around the polymer object.

6. The method of claim 1, further comprising: preparing a mold to support the polymer object, placing the polymer object within the mold, and sealing the flexible bag outside of the polymer object, the flow netting, and the mold.

7. The method of claim 1, wherein sealing the flexible bag comprises at least one of: heat-sealing the flexible bag around the polymer object, optionally using an iron; and sealing the flexible bag around the polymer object using sealant tape.

8. The method of claim 1, wherein the solvent comprises a first layer and a second layer, the first layer contacted with at least one surface of the polymer object; and the second layer contacted with at least another surface of the polymer object; such that a plurality of the surfaces of the polymer object are covered by the first and second solvent layers.

9. The method of claim 1, wherein said recovering the embedded fibers comprises at least one of: removing the polymer substrate from the flexible bag including optionally moving the polymer substrate to a waste storage container; and removing the embedded fibers from the flexible bag.

10. The method of claim 1, further comprising: flowing the solvent solution out of the flexible bag through the outlet feed line and flushing out the flexible bag using a solvent, surfactant, or water to clean the flexible bag for reuse.

11. The method of claim 1, further comprising: boring one or more openings in a hollow composite polymer object, the method comprising: such that an interior surface area of the hollow composite polymer object is accessible for a contouring bag or contouring film.

12. A system for recycling a composite polymer object, the system comprising:
a solvent flow path;
a solvent reservoir in the solvent flow path, the solvent reservoir containing solvent and having a solvent reservoir outlet, the solvent being degratively reactive with thermoset polymer;
a flexible bag in the solvent flow path, the flexible bag having an object compartment, a solvent inlet fluidly connected to the object compartment, and a solvent outlet fluidly connected to the object compartment, the solvent inlet positioned downstream of the solvent reservoir outlet; and
a solvent circulation pump positioned in the solvent flow path in fluid communication with the solvent reservoir and the flexible bag.

13. The system of claim 12, wherein the solvent reservoir further comprises a heating element for heating the solvent in, or when leaving, the solvent reservoir.

14. The system of claim 12, further comprising a spacer, optionally a rigid spacer, positioned in the flexible bag to keep the flexible bag away from the composite polymer object.

15. The system of claim 14, wherein the spacer comprises at least one of:
a flow netting contacting a surface of the composite polymer object; and
a plurality of bosses coupled to the flexible bag that contacts a surface of the composite polymer object;
for facilitating contact or flow of the solvent around the polymer object.

16. The system of claim 12, further comprising: preparing a mold to support the polymer object, wherein the mold is composed of at least one of the following: fiberglass, PTFE, vinylester and polyurethane.

17. The system of claim 12, wherein the system further comprises at least one of:
a positive displacement pump coupled to the solvent inlet of the flexible bag for providing a vacuum to the system;
a catch pot coupled to the positive displacement pump for preventing the positive displacement pump from taking in fluids from the system; and
a metering pump fluidly coupled to the solvent reservoir for providing a metered amount of solvent to the solvent reservoir to prepare a solvent solution in the solvent reservoir.

18. The system of claim 12, wherein multiple solvents are combined in the solvent reservoir.

19. The system of claim 12, wherein the system further comprises at least one of:
a transfer pump coupled to the second reservoir for transferring excess solution out of the second reservoir and a transfer container coupled to the transfer pump for containing the excess solution from the second reservoir; and
a priming reservoir containing an aqueous solution for priming the system and the solvent flow path, wherein the priming reservoir passes water through the system, optionally the entire system, so that the water pushes air out of the system to remove the air from the system prior to use.

20. The system of claim 12, wherein a polymer object is placed in the object compartment and wherein the polymer object is at least one of:
a thermoset polymer; and
at least a portion of a windmill blade or a boat, such as a boat hull.
